(19) United States
(12) Patent Application Publication
(10) Pub. No.: US 2024/0358021 A1
(43) Pub. Date: Oct. 31, 2024

(54) COMPOSITION COMPRISING POTASSIUM BICARBONATE AND USE THEREOF FOR TREATING AND/OR PROTECTING CROPS

(71) Applicant: SCEA DU CHATEAU MONTROSE, SAINT-ESTEPHE (FR)

(72) Inventor: Vincent DECUP, BRUGES (FR)

(21) Appl. No.: 18/571,952

(22) PCT Filed: Jun. 22, 2022
(86) PCT No.: PCT/FR2022/051220

§ 371 Date: Dec. 19, 2023

(30) Foreign Application Priority Data
Jun. 23, 2021 (FR) FR2106708

(51) Int. Cl. A01N 59/00; A01N 25/30; A01P 3/00

(52) U.S. Cl. CPC A01N 59/00; A01N 25/30; A01P 3/00

(57) ABSTRACT

The present invention relates to a novel composition comprising potassium bicarbonate and at least one excipient selected from the anionic surfactants belonging to the taurate family, the excipient preferably being acceptable in terms of plant protection and/or preferably being substantially biosourced. The present invention also relates to the use of such a composition and to a method comprising the use of such a composition, for treating and/or protecting crops, preferably vines, cucurbitaceae, solanaceae (preferably potatoes) and any combination thereof; more preferably vines. The present invention further relates to a method for protecting and/or treating crops, comprising the application of such a composition to the crops to be protected and/or treated, wherein the crops are preferably vines, cucurbitaceae, solanaceae (preferably potatoes) and any combination thereof; more preferably vines.

### FIELD OF THE INVENTION

The present invention is relevant to the phytosanitary field. It relates to compositions comprising potassium bicarbonate and at least one excipient selected from anionic surfactants belonging to the taurate family, the excipient preferably being phytosanitarily acceptable and/or preferably essentially biobased. The compositions are preferably in solid form. The present invention also relates to the use of such a composition and to a method comprising the use of such a composition, for treating and/or protecting crops, preferably vines, cucurbits, and Solanaceae.

### PRIOR ART

Phytopathogenic fungi are the main cause of plant disease. In particular, they are responsible for around 70% of crop diseases, of which 25% are caused by phytopathogens of the mildew type. Annual economic losses due to fungal diseases in pre- and post-harvest agriculture worldwide were estimated at over 200 billion euros in 2003. Controlling phytopathogenic fungi is therefore of major economic importance.

As a result, a broad range of antifungal products has been developed and is available on the market.

However, the vast majority of these products are not harmless to the environment, and contain pollutants that permanently contaminate the soil. Certain products have therefore been developed for use in organic farming. For example, sulfur- and copper-based products are respectively authorized for controlling powdery mildew and downy mildew on vines in organic farming. However, these substances are difficult to eliminate from the soil and can be harmful (particularly at higher concentrations). As a result, they gradually contaminate and pollute the soil, year after year, treatment after treatment. Furthermore, the methods used to obtain these substances (such as copper extraction methods) generally require the use of toxic products and/or the production of by-products that are harmful to the environment and hardly recoverable. Furthermore, because of all these detrimental impacts on the environment, these substances may also raise problems when it comes to their approval for use in organic farming. For example, the status of copper and its use are regularly reviewed at European level: copper could be used for a maximum of 6 kg/ha/year until 2018, and since 2019, for 4 kg/ha/year. It is therefore of strategic, economic and environmental importance for growers to have alternative solutions for combating plant pathogens such as those mentioned above, which are both obtained using production methods less harmful to the environment and better adapted to the growing demand for organic products, while still being effective.

Thus, there is a real need to reduce the environmental impact of antifungal products, by using raw materials and/or substances that can be obtained by biological methods (i.e., biobased raw materials and/or substances). Indeed, such production methods are less polluting than chemical ones (in particular, less polluting than petrochemical and carbochemical methods), and the substances produced in this way have little or no environmental toxicity or harm, and are more readily biodegradable. In this context, potassium bicarbonate is a compound that can be 100% biobased, and is both biodegradable and harmless to the environment. Some studies show that this compound has an antifungal effect.

For example, WO 96/00705 describes that formulations comprising sodium bicarbonate, potassium bicarbonate, Neodol® (Shell, Netherlands), kaolin and magnesium oxide would be effective in treating rot, powdery mildew and downy mildew on vines.

WO 95/12975 describes that a formulation comprising potassium bicarbonate, potassium carbonate, potassium oleate, potassium octanoate, butylated hydroxytoluene (BHT) and potassium polyacrylate would be effective in treating vine rot.

WO 94/18831 describes that a formulation comprising sodium bicarbonate, potassium bicarbonate, sodium carbonate, potassium oleate, potassium octanoate, guar gum and BHT would be effective in treating downy mildew on vines.

However, these various compositions include non-biobased, chemical-derived compounds (in particular, petrochemicals or carbochemicals, using synthesis methods that have a highly detrimental impact on the environment) that are harmful to the environment and non-biodegradable, or whose degradation by-products are harmful to the environment and non-biodegradable, such as Neodol®, magnesium oxide, butylated hydroxytoluene (BHT) or potassium polycrylate.

However, these various compositions include non-biobased, chemical-derived compounds (in particular, petrochemicals or carbochemicals, using synthesis methods that have a highly detrimental impact on the environment) that are harmful to the environment and non-biodegradable, or whose degradation by-products are harmful to the environment and non-biodegradable, such as Neodol®, magnesium oxide, butylated hydroxytoluene (BHT) or potassium polycrylate.

In addition, aqueous solutions of potassium bicarbonate have poor adhesion and low spreading on the foot of treated plants, in particular vines (especially on vine leaves) when no excipient is used.

In addition, these solutions are easily leached by bad weather (especially rainwater) when passing through a treated field.

There is therefore still a real need for new compositions to effectively prevent and/or treat phytopathogenic fungi, with optimized antifungal activity, improved adhesion, spreading, resistance to washout (leaching) and increased leaf longevity on the crops to be treated, in particular vine, cucurbit and solanaceous leaves, while at the same time being suitable for use in organic farming (in particular organic viticulture) and well tolerated by the crops treated.

The present invention meets this need. The present Inventors have developed a new composition which can be biobased (biosourced) and biodegradable, comprising potassium bicarbonate, and at least one excipient which can be essentially biobased and/or essentially biodegradable and/or essentially of natural origin and/or carrying a low-concern precautionary statement, selected from anionic surfactants belonging to the taurate family. The Inventors have shown that, unexpectedly, this new composition is particularly stable in solid form. The Inventors have further demonstrated that, unexpectedly, this composition enables crops to be protected and/or treated against phytopathogenic fungi, in particular powdery mildew, downy mildew and rot on vines and/or cucurbits and/or Solanaceae with high efficacy. In particular, the Inventors have shown that such a composition has a significant antifungal effect, making it possible to strongly inhibit the growth of the fungus responsible for downy mildew of vines and/or cucurbits and/or Solanaceae. This new composition shows a significant improvement in the properties of adhesion, spreading, resistance to leaching (rainfastness) and leaf longevity on vines, cucurbits and Solanaceae.

This formulation is all the more interesting in that its active ingredient, potassium bicarbonate, can be 100% biobased and, in particular, can be derived from a by-product of alcoholic fermentation, carbon dioxide, thereby making the most of the gases produced during alcoholic fermentation and limiting the release of carbon dioxide, a greenhouse gas that is detrimental to the ozone layer.

It is a novel combination of at least one anionic surfactant belonging to the taurate family, a compound which may also be biobased and/or biodegradable and/or natural and/or carry a low-concern precautionary statement, with potassium bicarbonate, thereby improving the spread and fixation of the active ingredient on the crop, as well as the stability of the composition in solid form, for long-term storage prior to use. By delaying water evaporation, this novel combination slows down leaching by rainwater, improves product dispersion on the leaf and the quality of the contact film formed on the leaf by the various co-formulants. This formulation also improves the compositions resistance to cold. The data also show that the presence of at least one additional excipient selected from anionic polyelectrolyte polymer surfactants, non-ionic surfactants, cationic surfactants and clays, further enhances the antifungal efficacy of the composition. The Inventors have also demonstrated a long-lasting, leaching (rainfast) protective effect. As a result, the frequency of treatment application can be kept to a minimum, limiting costs and environmental impact. In addition, the data show that such a composition does not present any phytotoxicity for crops.

This formulation can be in solid form, as a powder, tablet, granule, etc., while retaining these different properties. Indeed, the presence of at least one anionic surfactant belonging to the taurate family significantly increases the stability of the composition in solid form, for long-term storage prior to use. Granules are a particularly advantageous form, being less volatile than powder, easier to store and more durable than liquid compositions. However, none of the products currently marketed to professionals in the winegrowing and agricultural sectors are in granular form.

### DISCLOSURE OF THE INVENTION

In the context of the present invention, the Inventors have demonstrated, quite surprisingly, that a composition comprising potassium bicarbonate, and at least one excipient selected from anionic surfactants belonging to the taurate family, and optionally at least one additional excipient selected from surfactants (in particular a surfactant selected from anionic polyelectrolyte polymers, non-ionic surfactants, cationic surfactants), and optionally at least one additional excipient selected from clays, enables crops, in particular vines, cucurbits and Solanaceae, to be protected and/or treated with high efficacy and a long-lasting, leaching protective effect. In this way, the frequency of treatment application can be reduced to a minimum, limiting costs and environmental impact. In particular, the Inventors have shown that such a composition has a significant antifungal effect. These results are surprising, since such a combination was not previously known, a fortiori to have an antifungal effect or a crop protection or treatment effect. The data also show that such a composition has little or no phytotoxicity for crops.

The present invention therefore relates to a new composition comprising potassium bicarbonate, and at least one excipient selected from anionic surfactants belonging to the taurate family, said excipient preferably being a phytosanitarily acceptable excipient, and/or preferably an essentially biobased excipient, and/or preferably an essentially biodegradable excipient, and/or preferably an essentially naturally occurring excipient. Alternatively, or additionally, the excipient carries a low-concern precautionary statement.

Data further show that the presence of at least one additional excipient selected from anionic polyelectrolyte polymer surfactants, non-ionic surfactants, cationic surfactants, and clays, further enhances the antifungal efficacy of the composition. The present invention therefore concerns a composition comprising potassium bicarbonate, at least one excipient selected from anionic surfactants belonging to the taurate family, and at least one additional excipient selected from anionic polyelectrolyte polymer surfactants, nonionic surfactants, cationic surfactants, and clays, makes it possible to further increase the antifungal efficacy of the composition; said excipient preferably being a phytosanitarily acceptable excipient, and/or preferably an essentially biobased excipient, and/or preferably an essentially biodegradable excipient, and/or preferably an excipient of essentially natural origin. Alternatively, or additionally, the excipient carries a low-concern precautionary statement.

The Inventors have also shown that the composition can be in solid form and is particularly stable and suitable for medium- to long-term storage in this form. The invention therefore relates to a composition as defined above in solid form, preferably in the form of a powder, tablets, granules, or any combination thereof.

The present invention also relates to the use of such a composition and to a method comprising the use of such a composition, for treating and/or protecting crops, and/or controlling pathogenic fungi and/or fungal diseases on crops, the crops preferably being vines, cucurbits, Solanaceae, or any combination thereof, and most preferably vines.

The present invention further relates to a method for protecting and/or treating crops, as well as a method for controlling pathogenic fungi and/or fungal diseases on crops, comprising applying such a composition to the crops to be protected and/or treated, wherein the crops are preferably vines, cucurbits, Solanaceae, or any combination thereof, and preferably vines.

### DETAILED DESCRIPTION OF THE INVENTION

### Definitions

By “plant” is meant an organism belonging to the plant kingdom. The plant kingdom includes lineages that vegetate: i.e., that breathe, feed and grow like plants, according to conventional scientific classifications. The plant kingdom is a polyphyletic assemblage of photosynthetic organisms whose cells have cellulose walls. The term plant refers to both terrestrial plants (or green plants) and green algae, making up the Chlorobiont taxon, as well as red algae and brown algae. The plant group thus comprises two lineages, one of algae and the second of plants (particularly terrestrial plants), including bryophytes (mosses and liverworts), ferns (pteridophytes), gymnosperms and angiosperms. Advantageously, the vegetable is a plant.

By “phytosanitary” is meant what relates to the care/treatment of plants and higher fungi (or macroscopic fungi), in particular plants (or plant organisms) and fungi cultivated by man (plants/fungi not cultivated by man, so-called wild and/or endemic, may also be concerned by phytosanitary care/treatment, for environmental/conservatory reasons for example). Advantageously, the plants (or plant organisms) and/or fungi to be cared for/treated comprise at least a portion intended to be consumed by animals or processed for animal consumption. Animals include livestock (such as cattle, horses, mules, donkeys, cattle, sheep, goats, pigs), farmed poultry, aquaculture (fish and shellfish), farmed insects, pets (cats, dogs, reptiles, birds, etc.) and humans. Phytosanitary care/treatment may in particular include care/treatment aimed at controlling and/or increasing growth and/or development and/or yield, as well as care/treatment aimed at preventing and/or treating diseases which could for example affect said growth, said development said yield.

By “phytosanitary composition” is meant a composition having at least one phytosanitary effect and/or a composition suitable for phytosanitary use.

The phytosanitary effect may be an effect comprising or consisting of controlling and/or increasing growth and/or development and/or yield. The phytosanitary effect may be a therapeutic effect, preferably consisting of preventing and/or treating and/or controlling diseases of plant organisms. The therapeutic effect of a phytosanitary composition may therefore comprise, consist essentially of, or consist of, the prevention, treatment or control of pests, such as plants, animals, insects, parasites, viruses and fungi that are pathogenic/noxious/harmful/detrimental to the plant organism/crop to be treated. The therapeutic effect of a phytosanitary composition can therefore include the prevention, treatment or control of pathogenic/noxious/harmful/detrimental organisms for the plant organism/crop to be treated. In this case, the effect is pesticidal. The said pathogenic/noxious/harmful/detrimental organisms include plants, animals, insects, parasites, viruses and fungi (such as mosses, fungi, bacteria, competing plants, insects, rodents, mites, molluscs, worms, nematodes, viruses, etc.) competing with the plant organism/crop/crop plants or harming their growth or reproduction. The phytosanitary effect may therefore consist in repelling and/or keeping away these organisms (repellent effect). The phytosanitary effect may also include a fungicidal/antifungal/fungistatic effect (inhibition and/or prevention of the development and/or spread of fungi and/or lethal effect for fungi), bactericidal/antibacterial/bacteriostatic effect (inhibition and/or prevention of the development and/or spread of bacteria and/or lethal effect for bacteria), acaricide (inhibition and/or prevention of the development and/or spread of mites and/or lethal effect for mites), insecticide/insect repellent (inhibition and/or prevention of the development and/or spread of insects and/or lethal effect for insects), molluscicide (inhibition and/or prevention of the development and/or spread of molluscs (such as slugs and snails) and/or lethal effect for molluscs (such as slugs and snails)), nematicide (inhibition and/or prevention of the development and/or spread of nematodes and/or lethal effect for nematodes), parasiticide/antiparasiticide (inhibition and/or prevention of the development and/or spread of parasites and/or lethal effect for parasites), virucide/antivirus (inhibition and/or prevention of the development and/or spread of viruses and/or lethal effect for viruses), aphicide (inhibition and/or prevention of the development and/or spread of aphids and/or lethal effect for aphids), herbicide (or weedkiller, defoliant, phytocide or brushkiller: inhibition and/or prevention of the development and/or spread of undesirable plants (also known as weeds) and/or lethal effect on aphids for undesirable plants). The phytosanitary composition can also act according to mechanisms of competition, predation, mimicry, stimulation of natural defenses, or any combination of these mechanisms. Alternatively, or in combination with the therapeutic/pesticidal effect, the phytosanitary effect of a phytosanitary composition may comprise a beneficial effect on the plant organism/crop to be treated, such as a growth-enhancing effect, a flowering-stimulating effect, a fruit-growth-stimulating effect, a resistance-enhancing effect (to cold, heat, weather, pathogens etc.), a natural defenses-stimulating effect, or any combination of these effects.

Preferably, the phytosanitary effect comprises repulsion, competition, predation, mimicry, stimulation of natural defenses, bactericidal/antibacterial/bacteriostatic effect, fungicidal/antifungal/fungistatic effect, parasiticidal/antiparasitic effect, or any combination of these effects. Even more preferably, the phytosanitary effect comprises at least one fungicidal effect. Even more preferably, the phytosanitary effect consists essentially of at least one antifungal effect. Even more preferably, the phytosanitary effect consists of at least one antifungal effect. Even more preferably, the phytosanitary effect consists of an antifungal effect. Thus, the composition is preferably a fungicidal/antifungal phytosanitary composition, i.e., it possesses a fungicidal/antifungal effect (i.e., an effect of inhibition and/or prevention of the development and/or spread of fungi and/or lethal effect for fungi). The phytosanitary composition is preferably an antifungal composition suitable for use in the agricultural field (i.e., an agricultural phytosanitary composition), even more preferably an antifungal composition suitable for use in the viticultural field (i.e., a viticultural phytosanitary composition).

By “phytosanitary use” is meant a use producing at least one phytosanitary effect, the phytosanitary effect preferably being as defined above. Preferably, the phytosanitary use comprises, consists essentially of or consists of the use of a phytosanitary composition.

The use is preferably a fungicidal/antifungal use, i.e., it leads to a fungicidal/antifungal effect (i.e., an effect of inhibition and/or prevention of the development and spread of fungi and/or lethal effect for fungi). The use is preferably an antifungal use in the agricultural field (i.e., an agricultural phytosanitary use), even more preferably an antifungal use in the viticultural field (i.e., a viticultural phytosanitary use).

By “agricultural” or “agricultural field” is meant all that relates to agriculture and horticulture (i.e., the working of the land and the production of animals and plants). Thus, the agricultural area/field/specialty/activity comprises, consists essentially of, consists of or is an area/field/specialty/activity that comes under agriculture (i.e., the area devoted to or relating to working the land and producing animals and plants). The agricultural phytosanitary composition comprises, consists essentially of, consists of or is therefore a composition suitable for and/or a composition for working the land and producing animals and plants. The agricultural phytosanitary use comprises, consists essentially of, consists of or is therefore a use suitable for and/or in earthworks and animal and plant production.

By “vineyard” or “vineyard field” is meant all that relates to the vine and the wine production. Thus, the viticultural area/field/specialty/activity comprises, consists essentially of, consists of or is an area/field/specialty/activity that relates to the vine cultivation and wine production. The wine-growing phytosanitary composition comprises, consists essentially of, consists of or is therefore a composition suitable for and/or a composition for vine cultivation and wine production. The wine-growing phytosanitary use comprises, consists essentially of, consists of or is therefore a use suitable for and/or in vine cultivation and wine production.

By “crop” is meant a plant or fungus production derived from the exploitation of the land. The term “cultivation” can therefore refer both to the plant or fungus cultivated (e.g., a cultivated plant) before or after harvesting, to the plantation/field including the plant or fungus cultivated before or after harvesting, and to all the work and techniques used to process the land and to obtain consumer products (such as cultivated plants or fungi).

By “vine” is meant both a vine stock and a vine plantation (i.e., a set of vine plants or the grape variety of a vine). By “vine” or “vine plant” or “vine stock” is meant a sarmentose, climbing shrub with fruit in bunches (grapes). Vines can be grown for grape and/or wine production. Advantageously, the vine belongs to the Vitaceae family, which includes the genera Vitis, Parthenocissus and Ampelopsis (including the species Ampelopsis brevipedunculata). The vine belongs preferably to the genus Vitis, and even more preferably to the species Vitis vinifera.

By “cucurbit” is meant both a cucurbit plant and a cucurbit plantation (i.e., a set of cucurbit plants/feet). By “cucurbit” or “cucurbit plant” or “cucurbit foot” or “cucurbit plantation” is meant a plant belonging to the Cucurbitaceae family (Cucurbitaceae). The Cucurbitaceae is a family of dicotyledonous plants in the order Cucurbitales, mostly native to tropical and subtropical regions, comprising around 800 species in some 130 genera.

They are generally herbaceous, annual or perennial, creeping or climbing plants with tendrils on their stems, and sometimes shrubs. Flowers are unisexual, sometimes borne by the same plants (monoecious), sometimes by different plants (dioecious). Fruits are usually modified berries called peponids, more rarely dried fruits (capsules, samaras). Many cucurbit species are grown for their edible fruit (notably squash, zucchini, cucumbers, gherkins, melons, watermelons, chayotes, etc.) and sometimes for their seeds (oil squash, African pistachio, etc.).

The Cucurbitaceae family includes the following genera:
Bryonia (including, for example, dioecious bryonia),
Ecballium (including, for example, squirting cucumber),
Citrullus (including, for example, watermelon (Citrullus vulgaris) and true colocynth (Citrullus colocynthis)),
Cucumis (including, for example, cucumbers (Cucumis sativus) and melon (Cucumis melo),
Cucurbita (including various species of squash and zucchini),
Lagenaria (including, for example, gourds),
Luffa,
etc.

Thus, the cucurbit is advantageously selected from the genera Bryonia (preferably dioecious bryonia), Ecballium (preferably squirting cucumber), Citrullus (preferably watermelon (Citrullus vulgaris) or true colocynth (Citrullus colocynthis)), Cucumis (preferably cucumber (Cucumis sativus) or melon (Cucumis melo)), Cucurbita (preferably squash or zucchini), Lagenaria (preferably gourds), Luffa, and any combination thereof.

By “Solanaceae” is meant both a Solanaceae plant and a Solanaceae plantation (i.e., a set of Solanaceae plants/feet). By “solanaceous” or “solanaceous plant” or “solanaceous foot” or “solanaceous plantation” is meant a plant belonging to the Solanaceae family. A family of dicotyledonous plants (Magnoliopsida) belonging to the order Solanales. They are generally herbaceous plants, shrubs, trees or lianas with alternate, simple leaves without stipules. The family comprises around 100 genera and 2,700 species, and covers a wide range of habitats, morphologies and ecologies. This family includes food crops such as potatoe (Solanum tuberosum), tomatoe (Solanum lycopersicum), eggplant (Solanum melongena) and chili pepper (Capsicum). Many ornamental plants also belong to the Solanaceae family, including Petunia, Schizanthus, Salpiglossis and Datura. Some Solanaceae species, rich in alkaloids, are known for their medicinal uses, psychotropic effects or toxicity: belladonna, nightshade, brugmansia, Datura, mandrake, tobacco and others.

The Solanaceae family includes the genera Coeloneurum, Espadaea, Goetzea, Henoonia, Solanum and others. The Solanaceae is thus advantageously selected from these genera and any combination thereof.

Advantageously, the Solanaceae is selected from the subfamilies Browallioideae, Duckeodendron, Goetzeoideae, Nicotianoideae, Petunioideae, Schizanthoideae, Schwenckioideae, Solanoideae, Cestroideae, and any combination thereof. Solanaceae are preferably selected from potatoes (Solanum tuberosum), tomatoes (Solanum lycopersicum), eggplants (Solanum melongena), chili peppers (Capsicum), Petunia, Schizanthus, Salpiglossis, Datura, belladonna, nightshade, brugmansia, mandrake, tobacco, and any subspecies thereof, and any combination thereof (preferably potatoes (Solanum tuberosum), tomatoes (Solanum lycopersicum), eggplants (Solanum melongena), chili peppers (Capsicum), and any subspecies thereof, and any combination thereof; preferably potatoes (Solanum tuberosum), especially their subspecies, such as Solanum tuberosum L. subsp. Tuberosum, and Solanum tuberosum L. subsp. andigenum (Juz. & Bukasov) Hawkes).

By “active ingredient” or “active substance” is meant the chemical substance which, in a phytosanitary composition, a cosmetic composition or in a medicinal product, has at least one phytosanitary, cosmetic or therapeutic effect, respectively. In the case of a phytosanitary composition, the phytosanitary effect is preferably as defined above. The active ingredient is preferably essentially biobased.

By “potassium bicarbonate” or “potassium hydrogen carbonate” is meant a colorless, odorless basic salt with the chemical formula KHCO₃. Potassium bicarbonate is also known as potassium hydrogen carbonate. Its monoclinic crystals, with a specific gravity of 2.17, decompose between 100° C. and 200° C. It can be made by reacting potassium carbonate, water and carbon dioxide, according to the following chemical reaction:

K₂CO₃+H₂O+CO₂->2KHCO₃.

It can also be synthesized from potassium carbonate and water. Potassium bicarbonate is preferably essentially biobased.

By “excipient” or “additive” is meant any substance in a composition other than the active ingredient(s). The addition of an excipient to a composition is intended to give it a given stability, consistency, shape, dissolution property(ies), targeting property(ies), preservative property(ies), half-life, bioavailability, taste, color, aesthetic property(ies) and/or texture, or other particular physical, chemical, biological or taste characteristics.

An excipient is therefore defined more by its use than by a particular chemical composition, said use deriving in particular from its physico-chemical properties which make it suitable for fulfilling its role as an excipient.

The excipient may in particular be a stabilizing agent, a preservative, an antioxidant, a texturizing agent, a binder, an emulsifier, a colorant, a pigment, a corrosion inhibitor, a polymerization inhibitor, an anti-caking agent, surfactant (may also be called foaming agent, wetting agent, dispersant, emulsifier), antifoaming agent, an antileaching agent, a thickener, a solubilizer, a humectant, a desiccant, an antiozonant, an anti-UV agent (photoprotective; examples: “quencher”, UV absorber), a thermal stabilizer, an antifreeze agent (examples: ethylene glycol, diethylene glycol, propylene glycol, glycerol, methanol, isopropanol), a flame retardant (examples: brominated compound, phosphorus compound, antimony trioxide with a halogen donor), a processing agent (examples: lubricant, plasticizer, kerosene), an adhesion promoter, a solvent, a diluent, an antistatic agent, a buffer additive, an olfactory tracer (such as ethanethiol), an agent combining any of these characteristics.

The excipient preferably has no negative interaction, particularly chemical, with the active ingredient(s), i.e., the excipient induces no reduction in the desired activity/action/effect of the active ingredient(s), either before or after application/administration to/in the organism to be treated/protected. The excipient may also be neutral towards the active ingredient(s), i.e., it does not affect the activity/action/effect of the active ingredient(s) in any way. The excipient is preferably non-toxic (in particular for plant organisms to be treated, especially crops such as vines, cucurbits, Solanaceae; and animals, especially mammals and more particularly humans). The excipient is preferably essentially of natural origin. The excipient is preferably essentially biodegradable. Even more preferably, the excipient is essentially biobased. Particularly preferably, the excipient is essentially biobased and essentially biodegradable. Alternatively, or additionally, the excipient carries a low-concern precautionary statement.

By “phytosanitarily acceptable excipient” is meant an excipient suitable for phytosanitary use. In particular, it means an excipient suitable for incorporation into a phytosanitary composition. Advantageously, the phytosanitarily acceptable excipient does not reduce the desired phytosanitary activity/action/effect of the active ingredient(s) and/or composition. The phytosanitarily acceptable excipient is preferably non-toxic (in particular for the plant organisms to be treated, in particular crops, such as vines, cucurbits, Solanaceae; and animals, in particular mammals and more particularly humans). The excipient is preferably of natural origin. The excipient is preferably essentially biodegradable. The excipient is preferably still essentially biobased. The excipient is preferably biodegradable and/or biobased. Alternatively, or additionally, the excipient carries a low-concern precautionary statement. Advantageously, the phytosanitarily acceptable excipient has been registered or is in the process of being registered for phytosanitary use by the competent authorities in the territory concerned.

In the context of the present invention, the term “biobased”, when used in the context of any of the aspects/embodiments of the invention, may be considered to qualify any one of the following conditions, alone or in combination with at least one other of said conditions: biobased, biodegradable, natural, carrying a low-concern, phytosanitary acceptable precautionary statement. On the basis of this definition, the interpretation to be given to the term “biobased” throughout the present text will be easily accessible to the person skilled in the art according to the context.

For the purposes of the present invention, “advice statements” or “precautionary statements” or “precautionary advice statements” or “P statements” are indications present on the labels and/or packaging and/or instructions for use of compounds/products, giving information to the user on these compounds/products. This information indicates to the user the precautions to be taken and/or implemented, and/or the risks incurred when handling or using said compounds/products. According to Regulation (EC) No. 1272/2008, known as “CLP”, a precautionary statement, or “P-statement”, is

“A statement describing recommended measures to be taken to minimize or prevent adverse effects arising from exposure to a hazardous substance or mixture as a result of its use or disposal”. For the purposes of the present invention, the expression “product/compound/ingredient/excipient X with a low-concern precautionary statement” means that the product/compound/ingredient/excipient X displays, on its label and/or packaging and/or instructions for use:
little or no warning before use and/or of the risks involved; or
warnings/cautions of little or no concern and/or involving little or no risk;
little or no call for caution when using it and/or on the risks involved;
   where “not or little” (or “little or no”) means that if present, the warning message is given as part of the precautionary principle, but it is understood that the use of product X poses no risk (or significant risk) either to the user or to the environment. Preferably, the warnings/cautions indicate to the user that the handling and/or use of the products/compounds/ingredients/excipients involves(s) few or not very harmful risks and/or consequences for the user and/or the environment and/or the areas/sites treated with the products/compounds/ingredients/excipients. Even more preferably, the warnings/cautions are essentially of a general nature and/or correspond to recommendations for use of the product/compound/ingredient/excipient, it being understood that use in accordance with these recommendations involves no risk (or no significant risk) for the user and/or the environment and/or the areas/sites treated by the products/compounds/ingredients/excipients.

By “surfactant” is meant a compound that modifies the surface tension between two surfaces. Surfactants are amphiphilic molecules, i.e., they have two parts of different polarity: one lipophilic (fat-retaining) is apolar, the other hydrophilic (water-miscible) is polar. They thus enable two immiscible phases to be solubilized, by interacting with the apolar phase (i.e., lipophilic and therefore hydrophobic) via its hydrophobic part; and with the other phase, which is polar, via its hydrophilic part.

In general, a surfactant is a compound capable of modifying the surface tension of a liquid, particularly water, even when used in small quantities. With the exception of mineral salts or bases (except ammonia), most surfactants lower the surface tension of water. However, to determine whether they are predominantly hydrophilic or hydrophobic, we can calculate their HLB (Hydrophilic-Lipophilic Balance), which gives a numerical estimate of the balance between lipophilic and hydrophilic components.

Surfactants can be classified according to function and/or type. Functionally speaking, surfactants include:
detergents (with detergent and/or cleaning power. Detergents generally have an HLB ranging from 13 to 15);
solubilizers (for solubilizing substances that are normally insoluble in the solvent used. At very low concentrations, surfactants are capable of forming true solutions in an aqueous phase. When their concentration exceeds a particular value (the critical micellar concentration), the molecules of the solubilizing surfactant group together in aggregates called micelles. This occurs in such a way that their hydrophilic pole is the only one in contact with the water molecules. In this way, the insoluble substance is taken up by the micelles and incorporated into them. Solubilizers generally have an HLB ranging from 18 to 20);
foaming agents (promote foam formation, i.e., the dispersion of a large volume of gas in a small volume of liquid). Foaming agents adsorb to the water-air interface. They generally have an HLB ranging from 3 to 8);
wetting agents (by lowering the solid-liquid surface tension, wetting agents enable the liquid to spread more evenly over the solid, thus promoting wetting of the solid by the liquid. This wetting power helps to suspend solid particles in a liquid in which they are insoluble, by expelling the layer of air adhering to the particles that hinders dispersion in the liquid phase. Wetting agents generally have an HLB ranging from 13 to 15);
dispersing agents (to bind hydrophobic particles contained in a hydrophilic solution, such as water, thus creating a dispersion, i.e., an aqueous solution containing particles in suspension. These agents prevent flocculation of the particles, i.e., their aggregation into larger parts, which could then easily settle to the bottom of the solution. Dispersing agents generally have an HLB ranging from 6 to 8);
emulsifying agents (facilitating the formation of an emulsion between two immiscible liquids; generally having an HLB of less than 6 for an O/W emulsion (Oil in Water), or greater than 10 for a W/O emulsion (Water in Oil));
antiseptic surfactants (with bacteriostatic or bactericidal properties), and
any combination thereof.

Typologically, surfactants include anionic surfactants (the hydrophilic part is negatively charged), cationic surfactants (the hydrophilic part is positively charged), zwitterionic or amphoteric surfactants (the hydrophilic part has a positive and a negative charge, the overall charge is zero), non-ionic surfactants (the molecule has no net charge), and any combination thereof.

By “anionic surfactant” is meant a surfactant whose hydrophilic part is negatively charged. Anionic surfactants release a negative charge (anion) in aqueous solution. They have a relatively high hydrophilic/lipophilic balance (HLB) (8 to 18), as they have a more pronounced hydrophilic tendency. Examples of this type of surfactant include soaps, sulfated derivatives (e.g., sodium laureth sulfate, sodium lauryl sulfate and triethanolamine lauryl sulfate), sulfonated derivatives (e.g., sodium dioctylsufosuccinate), lipoamino acids, taurates, anionic polyelectrolyte polymer surfactants, and so on.

Soaps are fatty acid salts with the general formula RCOOM (R=long hydrocarbon chain, M=metal, alkali or organic base). Depending on the nature of the M group, a distinction is made between alkaline soaps (Na⁺, K⁺, NH₄⁺), metallic soaps (especially calcium soaps) and organic soaps (especially triethanolamine soaps, including triethanolamine stearate, for example) The anionic surfactants may be biobased and/or biodegradable and/or natural and/or carry a low-concern and/or phytosanitary acceptable precautionary statement. The anionic surfactant is preferably essentially biobased. The anionic surfactant is preferably selected from taurates, anionic polyelectrolyte polymers, and any combination thereof.

By “taurate” or “tauride” or “anionic surfactant belonging to the taurate family” is meant an anionic surfactant comprising a hydrophilic head consisting of N-methyltaurine (2-methylaminoethanesulfonic acid). Taurates are generally composed of a hydrophilic head group, consisting of N-methyltaurine (2-methylaminoethanesulfonic acid), and a lipophilic residue, consisting of a long-chain carboxylic acid (fatty acid), both linked by an amide bond. The fatty acids used may, for example, be selected from lauric acids (C12), myristic acids (C14), palmitic acids (C16), stearic acids (C18), oleic acids (C18:1), coconut fatty acids (C8-C18), etc., and any combination thereof (such as a mixture of oleic acids (C18:1) and coconut fatty acids (C8-C18)). The counterion may, for example, be selected from sodium, ammonium, alkali metals, alkaline earth metals, etc., and any combination thereof.

At room temperature, taurates are generally pasty masses, dissolving well in water and reacting neutrally to slightly alkaline (pH 7-8). Their toxicity is very low. They are readily biodegradable and not subject to bioaccumulation.

Due to their amide bond, taurates are stable over a wide pH range (approx. 2-10). They are very mild surfactants with good foaming power and high foam stability, even in the presence of fats and oils. Taurates retain their good washing properties even in hard water or seawater. Taurates also have good compatibility with non-ionic and anionic surfactants, suitable at concentrations of around 2% as co-surfactants.

Taurates can be biobased and/or biodegradable and/or natural and/or carry a low-concern and/or phytosanitary acceptable precautionary statement. The surfactant belonging to the taurate family is preferably essentially biobased.

The taurate is preferably selected from N-methyltaurates and any combination thereof; preferably from sodium N-methyltaurates, ammonium N-methyltaurates, calcium N-methyltaurates, alkali metal N-methyltaurates, alkaline earth metal N-methyltaurates, and any combination thereof; more preferably still from sodium N-methyltaurates. Advantageously, the taurate comprises, consists essentially of or consists of a sodium N-methyltaurate. Advantageously, the taurate is selected from compounds whose brand name is Adinol™, preferably Adinol™ OT-72 (Croda Inc., England) and any combination thereof.

By “anionic polyelectrolyte polymer surfactant” or “anionic polyelectrolyte polymer” is meant a polymer which carries negatively charged ionic or ionizable groups (polyanion). Examples of anionic polyelectrolyte polymers include pectins, alginates, poly(acrylic acid), lignosulfonates and others.

Anionic polyelectrolyte polymers may be biobased and/or biodegradable and/or natural and/or carry a low-concern precautionary statement and/or be acceptable from a plant health standpoint. The anionic polyelectrolyte polymer is preferably essentially biobased.

The anionic polyelectrolyte polymer surfactant is preferably selected from lignosulfonates, and any combination thereof. Advantageously, the anionic polyelectrolyte polymer surfactant comprises, consists essentially of or consists of a lignosulfonate.

By “lignosulfonate” or “lignin sulfonate” is meant an anionic polyelectrolyte polymer with at least one sulfonate group (chemical formula R—SO₃H). Lignosulfonates have preservative and/or dispersant properties. Lignosulfonates have a low environmental impact. A life cycle assessment (LCA) has shown that they offer an excellent alternative to petrochemical-based products.

Lignosulfonates can be biobased and/or biodegradable and/or natural and/or carry a low-concern and/or be phytosanitarily acceptable precautionary statement. In particular, they can be obtained from wood pulp (e.g., by-products of cellulose or pulp production). The lignosulfonate is preferably essentially biobased.

The lignosulfonate is preferably water-soluble.

The lignosulfonate is preferably selected from sodium lignosulfonates, ammonium lignosulfonates, calcium lignosulfonates, and any combination thereof; even more preferably from sodium lignosulfonates. Advantageously, the lignosulfonate comprises, consists essentially of or consists of sodium lignosulfonates. When the lignosulfonate is selected from sodium lignosulfonates, it preferably has the chemical formula C₂₀H₂₄Na₂O₁₀S₂.

Advantageously, the lignosulfonate is selected from compounds whose brand name is Ufoxane 3 ATM (Borregaard AS, Norway) and any combination thereof.

By “non-ionic surfactant” is meant a surfactant whose molecule carries no net charge (does not ionize in water). Non-ionic surfactants can be classified according to the nature of the bond between the hydrophilic and hydrophobic parts of the molecule.

Non-ionic surfactants include:
ester-linked surfactants (R—CO—O—R). Ester-linked surfactants include glycol esters (e.g., ethylene glycol stearate), glycerol esters (e.g., glycerol stearate, used as an emulsifier), polyoxyethylene glycol esters (obtained by the action of ethylene oxide on a fatty acid or a mixture of fatty acids), sorbitan esters, polyoxyethylene sorbitan esters (more commonly known as polysorbates);
ether-linked surfactants (R—O—R′), such as fatty alcohol ethers and polyoxyethylene glycol ethers (often used as emulsifiers);
amide-bonded surfactants (R—CO—NH—R′);
non-ionic ethoxylated alcohols (whose molecular formula may be: R(OC₂H₄)ₙOH).

Non-ionic surfactants can be biobased and/or biodegradable and/or natural and/or carry a low-concern and/or phytosanitary acceptable precautionary statement. The non-ionic surfactant is preferably essentially biobased. The non-ionic surfactant is preferably selected from ethoxylated alcohols. Advantageously, the non-ionic surfactant comprises, consists essentially of or consists of an ethoxylated alcohol.

By “ethoxylated alcohol” is meant a compound obtained by an ethoxylation reaction, i.e., by a process in which ethylene oxide reacts with an alcohol and/or a phenol. Ethylene oxide, also known as 1,2-Epoxyethane or Oxirane, is a compound with the empirical chemical formula C₂H₄O. Ethoxylated alcohols can be synthesized according to the following chemical reaction:

Alcohol (R—OH)+n ethylene oxide units (nC₂H₄O)->R(OC₂H₄)ₙOH.

Examples of ethoxylated alcohols are: glycolmonoalkylether, mercaptoethanol, aminoethanol, diethylene glycol, ethandiol, ethylene chlorohydrin, cyanoethanol, polyethylene glycol (PEG), laurylalcoholethoxylate, phenolethoxylate, nony-phenolethoxylate.

Ethoxylated alcohols may be biobased and/or biodegradable and/or natural and/or carry a low-concern and/or acceptable phytosanitary precautionary statement. The ethoxylated alcohol is preferably essentially biobased.

The alcohol can be primary (in which the hydroxyl group (—OH) is carried by a primary carbon atom, i.e., bonded to only one other carbon atom), secondary (in which the hydroxyl group is carried by a secondary carbon, i.e., bonded to two other carbons), tertiary (in which the hydroxyl group is carried by a tertiary carbon atom, i.e., bonded to three carbon atoms) or cyclic/phenolic (in which the hydroxyl group is carried by a carbon present in a ring). Ethoxylated alcohols can therefore be classified as primary ethoxylated alcohols, secondary ethoxylated alcohols, tertiary ethoxylated alcohols and phenolic/cyclic ethoxylated alcohols respectively. The ethoxylated alcohol is preferably selected from non-ionic ethoxylated secondary alcohols (e.g., obtained from a secondary alcohol, or comprising a secondary alcohol)) and any combination thereof. Advantageously, the ethoxylated alcohol comprises, consists essentially of or consists of a non-ionic ethoxylated secondary alcohol. The ethoxylated alcohol is preferably selected from non-ionic C₈-C₁₈ ethoxylated secondary alcohols and any combination thereof. Advantageously, the ethoxylated alcohol comprises, consists essentially of or consists of a nonionic C₈-C₁₈ ethoxylated secondary alcohol. Preferably, the ethoxylated alcohol is still a nonionic C₈-C₁₈ ethoxylated secondary alcohol. Advantageously, the ethoxylated alcohol has the empirical formula C₁₂₋₁₄H₂₅₋₂₉O[CH₂CH₂O]ₓH. Advantageously, the ethoxylated alcohol is selected from compounds whose brand name is Tergitol®, preferably Tergitol® 15-5-12 (Sigma-Aldrich, USA or Dow Chemical, USA) and any combination thereof.

By “cationic surfactant” is meant a surfactant whose hydrophilic part is positively charged. Cationic surfactants release a positive charge (cation) in aqueous solution. They have bacteriostatic and emulsifying properties. They are generally nitrogen-based products (with a positively charged nitrogen atom). Examples include quaternary ammonium salts (such as alkyltrimethyl ammonium salts (e.g., alkyltrimethyl ammonium bromide), alkylbenzyldimethyl ammonium salts (e.g., benzalkonium chloride), organo-mineral polymers, protonated amines, etc.).

Cationic surfactants may be biobased and/or biodegradable and/or natural and/or carry a low-concern and/or acceptable phytosanitary precautionary statement. The cationic surfactant is preferably essentially biobased.

The cationic surfactant is preferably selected from organo-mineral polymers, and any combination thereof. Advantageously, the cationic surfactant comprises, consists essentially of or consists of an organo-mineral polymer.

By “organo-mineral polymer” or “hybrid polymer” is meant a polymer comprising organic and inorganic components. Organo-mineral polymers include, for example, silanes, siloxanes, etc. Organo-mineral polymers may be biobased and/or biodegradable and/or natural and/or carry a low-concern and/or phytosanitary acceptable precautionary statement. The organo-mineral polymer is preferably essentially biobased. The organo-mineral polymer is preferably selected from siloxanes and any combination thereof.

By “siloxane” is meant a class of silicon compounds (organosilicones), having a repeating unit based on silicon and oxygen (chemical formula: —[O—Si(CH₃)₂]ₙ—). The empirical formula for siloxanes is R₂SiO, where R is a radical group which may be organic. These compounds can be organic and inorganic hybrids. The organic chains impart hydrophobic properties to the compound, while the —Si—O—Si—O— main chain is purely inorganic. Examples of siloxanes include alkylsiloxanes, such as dimethylsiloxanes (of the formula [SiO(CH3)2]n), diphenylsiloxanes (of the formula [SiO(C6H5)2]n), polysiloxanes (polymerized siloxanes, such as silicones), polydimethylsiloxanes (PDMS) and so on. The siloxane is preferably water-soluble.

Siloxanes may be biobased and/or biodegradable and/or natural and/or carry a low-concern and/or phytosanitarily acceptable precautionary statement. The siloxane is preferably essentially biobased.

The siloxane is preferably selected from alkylsiloxanes and any combination thereof; even more preferably selected from polydimethylsiloxanes (PDMS) and any combination thereof. Advantageously, the siloxane comprises, consists essentially of or consists of a polydimethylsiloxane, preferably absorbed. Advantageously, the siloxane has the empirical formula (C2H6Osi)ₙ. Advantageously, the siloxane is selected from compounds whose brand name is Rhodorsil®, preferably Rhodorsil® EP 6703 (Solvay, Belgium) and any combination thereof.

By “water-soluble polymer” is meant a polymer that can form a solution in water. Water-soluble polymers contain hydrophilic groups which, among other things, make them soluble in water.

These hydrophilic groups can be:
in the main chain: oxygen and nitrogen, which can form hydrogen bonds;
in the side chains: hydroxyl (—OH), amine (—NH3), salts of organic acids (—COO—), etc., and any combination thereof.

Water-soluble polymers can be:
natural polymers (e.g., dextrin, casein, dextran, pullulan);
artificial polymers (e.g., cellulose ethers);
synthetic polymers;
polyethers: polyethylene glycol (PEG);
vinyls: polyvinyl alcohol (PVAL), polyacrylamide, polyvinylpyrrolidone (PVP), etc.

Water-soluble polymers can also be biobased and/or biodegradable and/or natural and/or carry(s) a low-concern and/or phytosanitarily acceptable precautionary statement.

Examples of water-soluble polymers include anionic polyelectrolyte polymers (such as lignosulfonates), organo-mineral polymers (such as siloxanes), etc.

By “clay” or “clay mineral” is meant a natural rock material based on hydrated silicates or aluminosilicates (or hydrated aluminum silicate) with a lamellar structure, generally derived from the alteration of silicates with a three-dimensional structure, such as feldspars. Clays have purifying, astringent and antiseptic properties.

Clays are essentially natural and can be acceptable from a phytosanitary point of view.

The clay is preferably selected from silicates and any combination thereof. Advantageously, the clay comprises, consists essentially of or consists of a silicate.

By “silicate” is meant a salt combining silicon dioxide SiO2 with other metal oxides. Silicates include minerals with a silicate composition, silica polymorphs, phyllosilicates and others. The “Phyllosilicates” are minerals of the silicate group built by stacking tetrahedral layers (“T”) where the tetrahedra share three out of four vertices (“basal” oxygens), the fourth vertex (“apical” oxygen) being connected to an octahedral layer (“0”) occupied by different cations (Al, Mg, Fe, Ti, Li, etc.). Examples of phyllosilicates include compounds belonging to the kaolinite group. By “kaolinite” is meant a mineral species composed of hydrated aluminum silicate. The kaolinite group includes the following isostructural minerals:
dickite Al₂Si₂O₅(OH)₄,
endellite Al₂Si₂O₅(OH)₄·2 H₂O;
halloysite Al₂Si₂O₅(OH)₄ with traces of: Ti, Ca, Na, K, Fe, Cr, Mg, Ni, and/or Cu;
kaolinite Al₂Si₂O₅(OH)₄;
nacrite Al₂Si₂O₅(OH)₄;
odinite (Fe,Mg, Al,Fe,Ti,Mn)_{2.5}(Si,Al)₂O₅(OH)₄.

The silicate is preferably selected from phyllosilicates and any combination thereof; even more preferably selected from kaolinites and any combination thereof. Advantageously, the silicate comprises, consists essentially of or consists of a phyllosilicate, preferably a kaolinite. Advantageously, the silicate is a sedimentary kaolinite from the Charentes basin, preferably having the empirical formula Al₂Si₂O₅(OH)₄. Advantageously, the siloxane is selected from compounds whose brand name is Argirec™, preferably Argirec™ B22 (LEHVOSS Group, Germany) and any combination thereof.

By “glycerol” or “glycerin” (these two terms being considered synonymous and interchangeable here) or “1,2,3-propanetriol”, is meant a chemical compound with the formula HOH₂C—CHOH—CH₂OH. At room or ambient temperature (10° C.-40° C.), it is a colorless, viscous, odorless liquid, very low in toxicity in concentrated form, with a sweet taste. Glycerol can remain liquid at relatively low temperatures (below 10° C.). Its molecule has three hydroxyls corresponding to three alcohol functions, which are responsible for its solubility in water and its hygroscopic nature.

By “content” is meant the quantity of an object (such as a substance, compound, ingredient, effect, activity, etc.) contained in a mixture (such as a composition), as a percentage. The content may, for example, be expressed by weight relative to the total weight of the mixture or composition.

By “essentially free of the compound/ingredient” or “composition essentially free of the compound/ingredient” or “composition essentially free of the compound/ingredient” is meant a mixture or composition which contains a content of said compound or ingredient of less than 15% by weight relative to the total weight of the mixture or composition, preferably a compound/ingredient content of less than 10% by weight relative to the total weight of the mixture or composition, more preferably still less than 7.5% by weight, preferably still less than 5% by weight, more preferably less than 2.5% by weight, even more preferably less than 1% by weight, even more preferably less than 0.5% by weight, even more preferably less than 0.4% by weight, even more preferably less than 0.3% by weight, even more preferably less than 0, 2% by weight, preferably less than 0.1% by weight, preferably less than 0.09% by weight, preferably less than 0.05% by weight, preferably less than 0.01% by weight, preferably less than 0.005% by weight, preferably less than 0.001% by weight, based on the total weight of the mixture or composition.

By “fermentation” is meant a metabolic process carried out by a living microorganism, in particular a bacterium, involving the partial or total conversion (or degradation) of one or more substrates into at least one metabolite or fermentation product, usually by redox. Fermentation can be carried out in an aerobic atmosphere (in the presence of oxygen, O₂) or in an anaerobic atmosphere (in the absence of oxygen).

Several types of fermentation can be distinguished, depending on the fermentation product(s) (also called metabolite(s)) obtained by this metabolic process. For example, alcoholic fermentation occurs when the fermentation products obtained consist of a mixture of at least one alcohol, such as ethanol, and gas (most often carbon dioxide, also known as carbon dioxide, or carbon dioxide, with the chemical formula CO₂). Mixed fermentation occurs when a more complex mixture of fermentation products is obtained. This mixture may, for example, comprise one or more alcohols, such as ethanol, butanol; one or more carboxylic acids or salts thereof, such as acetic acid or acetate, formic acid or formate, butyric acid; lactic acid or lactate; one or more gases, such as dihydrogen (H₂), carbon dioxide (CO₂), carbon monoxide (CO) or dioxygen (O₂). Fermentation is preferably alcoholic. Alcoholic fermentation is preferably plant fermentation. Alcoholic fermentation is preferably wine fermentation. Wine fermentation comprises, consists of, consists essentially of or is the transformation of at least part of a vine (preferably the fruit of the vine, i.e., the grape), into wine or other alcohol. Preferably, fermentation comprises at least the formation of carbon dioxide (chemical formula CO₂).

By “solid composition” or “in solid form” or “in the solid state” is meant a composition or mixture which is neither in the liquid nor in the gaseous state. Solid compositions can take the form of powders, granules, tablets, or even larger assemblies (such as aggregates, loaves, agglomerates, etc.). The solid composition is preferably essentially liquid-free, more preferably liquid-free. The solid composition is preferably essentially free of water, preferably free of water.

By “nanoparticle” is meant an object whose three dimensions are on the nanometric scale, i.e., a particle with a nominal diameter of less than approximately 100 nm (for example, as defined by ISO standard TS/27687).

By “powder” is meant a solid present in the form of small pieces, generally smaller than a tenth of a millimeter (100 μm) in size.

By “granulate” or “granule” or “granulated” is meant a solid present in the form of small pieces or grains, generally of a size greater than or equal to one tenth of a millimeter (100 μm), but less than one tenth of a centimeter (10 cm).

By “tablet” is meant a solid form obtained by agglomerating a volume of particles (powder or granules) by compression. The tablet may be coated, film-coated, effervescent, dispersible, or any combination thereof.

By “aqueous solution” is meant a homogeneous mixture obtained by dissolving at least one substance (or chemical species or ingredient or compound), whether solid, liquid or gaseous, in water. An aqueous solution is therefore a liquid phase containing several chemical species, including an ultra-majority species, water (H₂O, the solvent), and at least one ultra-minority species, the solute (i.e., the dissolved substance, chemical species, ingredient or compound). Advantageously, the aqueous solution is a liquid, suspension, emulsion or true solution of a product, diluted in water.

By “sprayable aqueous solution” is meant an aqueous solution that can be sprayed as fine liquid droplets or in powder form. Advantageously, the sprayable aqueous solution is in suspension, emulsion or solution in a gaseous medium, preferably in an inert gas. Advantageously, the sprayable aqueous solution is presented in the form of a pulverizer, vaporizer, aerosol or spray.

By “spray” is meant the projection of an aqueous solution in the form of fine liquid droplets, in aerosol form, in vapor form, or in powder form, onto an object, preferably a crop, preferably a vine.

By “ingredient of natural origin” or “excipient of natural origin”, is meant an ingredient or a compound or an excipient which comes from nature, i.e., has been obtained from a natural element (e.g., a plant, a fungus, a mineral, an insect, an animal).

By “biobased ingredient” or “biobased excipient” is meant an ingredient or compound or excipient that is derived from a living organism, i.e., obtained from a living organism (e.g., microorganism, bacterium, plant, alga, fungus, yeast, insect, animal), and/or produced/secreted by a living organism and/or derived from a living organism. A biobased ingredient/component/excipient can therefore be obtained from biomass. In particular, a biobased ingredient/compound/excipient can be derived from biomass of bacterial, fungal, animal or plant origin. A biobased ingredient/component/excipient can in particular be obtained using an enzyme derived from a living organism and/or produced/secreted by a living organism and/or obtained from a living organism. A biobased ingredient/component/excipient is thus obtained by an essentially biological process, preferably by a biological process.

By “biodegradable ingredient” or “biodegradable excipient” is meant an ingredient or substance or compound or excipient capable of undergoing biodegradation. Biodegradation is the breakdown of organic matter by living organisms, such as micro-organisms like bacteria, fungi or algae. An ingredient or a substance or a compound or an excipient is biodegradable when it can break down into materials and/or elements that have no harmful effect on the natural environment, under the action of living organisms, such as micro-organisms like bacteria, fungi or algae. Materials and/or elements that have no damaging effect on the natural environment include, consist essentially of or consist of carbon dioxide, methane, water and biomass.

By “essentially biodegradable compound/ingredient” or “essentially biodegradable excipient” is meant a compound or ingredient or an excipient of which at least 80% by weight relative to the total weight of the compound or ingredient is biodegradable, preferably at least 85% by weight, preferably at least 90% by weight, even more preferably at least 92.5% by weight, even more preferably at least 95% by weight, more preferably at least 97.5% by weight, even more preferably at least 99% by weight relative to the total weight of the compound or ingredient is biodegradable. In other words, an essentially biodegradable compound/ingredient/excipient is one whose residual, non-degraded quantity after biodegradation is less than 20% by weight relative to the total weight of the compound/ingredient/excipient before biodegradation, preferably less than 15% by weight, more preferably less than 10% by weight, even more preferably less than 7.5% by weight, even more preferably less than 5% by weight, most preferably less than 2.5% by weight, even more preferably less than 1% by weight, even more preferably less than 0.5% by weight, even more preferably less than 0.4% by weight, even more preferably less than 0.3% by weight, even more preferably less than 0.2% by weight, even more preferably less than 0.1% by weight, better still less than 0.09% by weight, better still less than 0.05% by weight, better still less than 0.01% by weight, better still less than 0.005% by weight, better still less than 0.001% by weight, based on the total weight of the compound/ingredient before biodegradation.

By “essentially biobased compound/ingredient/excipient” is meant a compound or ingredient or excipient at least 80% by weight of which, based on the total weight of the compound or ingredient or excipient, is biobased, preferably at least 85% by weight, more preferably at least 90% by weight, even more preferably at least 92.5% by weight, even more preferably at least 95% by weight, more preferably at least 97.5% by weight, even more preferably at least 99% by weight, even more preferably at least 99.1% by weight, even more preferably at least 99.2% by weight, even more preferably at least 99.3% by weight, even more preferably at least 99.4% by weight, even more preferably at least 99.5% by weight, even more preferably at least 99.6% by weight, even more preferably at least 99, 7% by weight, better still of which at least 99.8% by weight, better still of which at least 99.9% by weight, better still of which at least 99.95% by weight, better still of which at least 99.99% by weight relative to the total weight of the compound or ingredient or excipient is biobased.

By “prevention” or “prevention of a disease” or “prevention of the onset of a disease” is meant the reduction of the risk of the onset, development or amplification of a disease, the causes of a disease, the symptoms of a disease, the effects (or consequences, preferably the harmful, deleterious effects/consequences) of a disease, or any combination thereof; and/or delaying the onset, development or amplification of a disease, the causes of a disease, the symptoms of a disease, the effects (or consequences, preferably the harmful, deleterious effects/consequences) of a disease, or any combination thereof.

By “treatment” or “treatment of a disease”, or “control of a pathogen”, or “control of a disease” is meant the reduction, inhibition, stabilization and/or disappearance of a disease, the causes of a disease, the symptoms of a disease, the effects (or consequences, preferably the harmful, deleterious effects/consequences) of a disease, or any combination thereof.

By “fungi” or “fungus” is meant here a eukaryotic organism belonging to the kingdom Fungi (also known as Mycota or Mycetes or fungi), the kingdom Oomycota (also known as pseudochampi; includes in particular the division Oomycetes) or the class Plasmodiophoromycetes. Fungi are a broadly diversified group, ranging from microscopic single-cell organisms (yeasts) and multi-cell organisms (molds) to “higher fungi” (macroscopic fungi), most of which have a foot and a cap. Fungi are characterized by the simultaneous existence of a peripheral cell wall and turgid vacuoles in the cytoplasm, their undifferentiated vegetative body and peptido-polyosidic wall, and the absence of chloroplasts, chlorophyll and starch. They are carbon heterotrophs.

By “pathogenic fungus” is meant a fungus or other filamentous organism belonging to species of parasitic fungi that cause disease in living organisms. The disease may be a cryptogamic disease (also known as a fungal disease) or a mycosis. A cryptogamic disease, or fungal disease, is a disease caused to a plant by a parasitic fungus or other filamentous organism (in the case of Oomycetes). When it affects an animal, the term “mycosis” is used.

The pathogenic fungus is preferably a phytopathogenic fungus.

By “phytopathogenic fungi” is meant species of parasitic fungi that cause cryptogamic diseases (also known as fungal diseases) in plants. These fungi belong to the various groups of the eumycetes or “true fungi” kingdom: ascomycetes, basidiomycetes, chytridiomycetes, zygomycetes and deuteromycetes (imperfect fungi). Pathogens responsible for cryptogamic diseases also include protists, such as plasmodiophoromycetes (whose most important genera are Plasmodiophora and Spongospora), and oomycetes (which include the Peronosporaceae family (agents of downy mildew)).

The pathogenic (or phytopathogenic) fungus is preferably selected from:
species causing major vineyard diseases, such as vine downy mildew (Plasmopara viticola), vine powdery mildew (Uncinula necator and/or Erysiphe necator) and vine rot (Botrytis cinerea),
species causing major diseases of Solanaceae, such as Solanaceae downy mildew (Phytophthora parasitica and/or Phytophtora infestans), and
species causing major diseases of cucurbits, such as cucurbit downy mildew (Pseudoperonospora cubensis),
   said fungal pathogen preferably being grapevine downy mildew (Plasmopara viticola).

Even more preferably, the pathogenic fungus (or phytopathogen) is selected from species belonging to the Peronosporaceae family (agents of downy mildew), in particular vine downy mildew (Plasmopara viticola).

By “vine downy mildew” is meant a fungus (or pseudo-fungus) belonging to the species Plasmopara viticola, of the family Peronosporaceae and class Oomycetes. Vine downy mildew exists in the form of free spores or mycelium that can only grow inside the vine tissue it parasitizes. Plasmopara viticola is an obligate endoparasite that develops mainly in the green tissues of vines, particularly in leaf parenchyma. It lives at the expense of the tissues it parasitizes, which it eventually destroys. During its development cycle, P. viticola remains essentially in diploid form. P. viticola is also characterized by the fact that the filaments of its mycelium have no partitions, the wall is cellulosic (unlike Eumycetes, which contain chitin) and the zoospores are biflagellate.

By “vine powdery mildew” is meant a fungus belonging to the species Erysiphe necator. Erysiphe necator is a microscopic, filamentous fungus of the Ascomycetes division, an obligate parasite of Vitaceae, mainly the Vitis genus. It is responsible for vine powdery mildew (also known as powdery mildew in Canada). It is also known as Uncinula necator. Powdery mildew is an ectoparasite that appears on the surface of all growing herbaceous organs of the vine, notably on young herbaceous shoots, leaves, bunches (of grapes) and shoots.

By “vine rot” or “gray mold” is meant a haploid fungus belonging to the species Botrytis cinerea, of the Sclerotiniaceae family, of the Ascomycota division. This phytopathogenic fungus is responsible for gray mold, a fungal disease that affects a number of crops of major agronomic interest, including vines, sunflowers, tomatoes and strawberries. Infection begins with the germination of conidia in the presence of water and nutrients found on damaged organs such as flower debris, and sometimes on leaves. Contamination then spreads to the berries/fruits. Before veraison, berry infection remains latent, with no apparent symptoms, then from veraison onwards, the mycelium already present begins to grow.

By “solanaceous downy mildew” is meant a fungus (or pseudo-fungus) belonging to the Phytophthora parasitica species and/or the Phytophtora infestans species, of the Peronosporaceae or Pythiaceae family and the Oomycetes class. Solanaceous downy mildew takes the form of spores that develop on leaves, spreading throughout the crop at average temperatures (above 10° C.).

By “cucurbit downy mildew” is meant a fungus (or pseudo-fungus) belonging to the species Pseudoperonospora cubensis, in the family Peronosporaceae and class Oomycetes. Cucurbit blight is an obligate biotrophic parasite, absolutely dependent on its host plant for growth and survival. It can only survive outside its host in the form of oospores.

In the context of the present invention, the term “no or little X” or “little or no X” should be understood as:
either the absence of X;
or an undetectable and/or insignificant presence of X.

### Composition

In the context of the present invention, the Inventors have developed a new composition based on potassium bicarbonate. The Inventors have thus demonstrated, quite surprisingly, that a composition comprising potassium bicarbonate, and at least one excipient selected from anionic surfactants belonging to the taurate family, can effectively protect and/or treat crops, in particular vines, cucurbits, solanaceous plants, or any combination thereof, preferably vines. The data show that, unexpectedly, application of this composition enables crops (such as vines, cucurbits, Solanaceae, or any combination thereof, preferably vines) to be protected and/or treated against phytopathogenic fungi, in particular powdery mildew, downy mildew and rot on vines and/or cucurbits and/or Solanaceae with high efficacy. In particular, the Inventors have shown that such a composition has a significant antifungal effect, making it possible to strongly inhibit the growth of the fungus responsible for vine downy mildew. Surprisingly, this new formulation shows a significant improvement in the properties of adhesion, spreading, resistance to leaching and longevity on the leaves of vines, cucurbits, solanaceous plants, or any combination thereof, preferably vines. The Inventors have also demonstrated a long-lasting, leaching protective effect. As a result, the frequency of treatment application can be reduced as much as possible, limiting costs and environmental impact. The data also show that such a composition is not phytotoxic to crops.

The present invention therefore relates to a new composition comprising:
potassium bicarbonate, and
at least one excipient selected from anionic surfactants belonging to the taurate family, said excipient preferably being a phytosanitarily acceptable excipient, and/or preferably an excipient essentially biobased, and/or an excipient essentially biodegradable, and/or an excipient essentially of natural origin, and/or preferably carrying a low-concern precautionary statement.

The present invention also relates to a composition composed essentially of, or consisting essentially of, or consisting of:
potassium bicarbonate; and
at least one excipient selected from anionic surfactants belonging to the taurate family, said excipient preferably being a phytosanitarily acceptable excipient, and/or preferably an excipient essentially biobased, and/or an excipient essentially biodegradable, and/or an excipient essentially of natural origin, and/or preferably carrying a low-concern precautionary statement.

Advantageously, the potassium bicarbonate and/or the excipient is/are essentially of natural origin. According to a preferred embodiment, the potassium bicarbonate and/or the excipient is/are essentially biobased. According to a preferred embodiment, the potassium bicarbonate and/or the excipient is/are biobased. According to a preferred embodiment, combinable with any of the embodiments presented herein, the excipient is essentially biodegradable, preferably the excipient is biodegradable. According to a preferred embodiment, the potassium bicarbonate and/or the excipient is/are essentially biodegradable. According to a preferred embodiment, combinable with any of the embodiments presented herein, the excipient is essentially of natural origin, preferably the excipient is of natural origin. According to a preferred embodiment, the potassium bicarbonate and/or the excipient is/are essentially of natural origin. According to a preferred embodiment, combinable with any of the embodiments presented herein, the excipient carries a low-concern precautionary statement. According to a preferred embodiment, the potassium bicarbonate and/or the excipient carry(s) a low-concern precautionary statement.

The data obtained by the Inventors also show that the presence of at least one additional excipient selected from anionic polyelectrolyte polymer surfactants, non-ionic surfactants and cationic surfactants further enhances the composition's antifungal efficacy, protection durability and resistance to leaching. Advantageously, the composition according to the invention therefore also comprises at least one additional excipient selected from anionic polyelectrolyte polymer surfactants, non-ionic surfactants, cationic surfactants, and any combination thereof.

The present invention therefore also relates to a novel composition comprising, or consisting essentially of, or consisting of:
potassium bicarbonate;
at least one excipient selected from anionic surfactants belonging to the taurate family, said excipient preferably being a phytosanitarily acceptable excipient, and/or preferably an essentially biobased excipient, and/or an essentially biodegradable excipient, and/or an excipient essentially of natural origin, and/or preferably carrying a low-concern precautionary statement; and
at least one additional excipient selected from anionic polyelectrolyte polymer surfactants, non-ionic surfactants, cationic surfactants, and any combination thereof;
   the anionic polyelectrolyte polymer surfactants being preferably selected from sulfonates, and any combination thereof; the nonionic surfactants being preferably selected from ethoxylated alcohols, and any combination thereof; the cationic surfactants being preferably selected from organo-mineral polymers, and any combination thereof;
   said additional excipient preferably being water-soluble; said additional excipient preferably being a phytosanitarily acceptable excipient, and/or preferably an essentially biobased excipient, and/or an essentially biodegradable excipient, and/or an excipient essentially of natural origin, and/or preferably carrying a low-concern precautionary statement.

The data show that the composition's antifungal efficacy, protection durability and resistance to leaching are particularly high when the anionic polyelectrolyte polymer surfactant comprises a sulfonate, the nonionic surfactant comprises an ethoxylated alcohol and/or the cationic surfactant comprises an organo-mineral polymer.

Advantageously, the composition according to the invention therefore further comprises at least one additional excipient selected from anionic polyelectrolyte polymer surfactants, selected from sulfonates, and any combination thereof; nonionic surfactants selected from ethoxylated alcohols, and any combination thereof; cationic surfactants selected from organo-mineral polymers, and any combination thereof; and any combination thereof.

Thus, in a particularly preferred embodiment, the composition comprises, or consists essentially of, or consists of:
potassium bicarbonate;
at least one excipient selected from anionic surfactants belonging to the taurate family, said excipient preferably being a phytosanitarily acceptable excipient, and/or preferably an essentially biobased excipient, and/or an essentially biodegradable excipient, and/or an excipient essentially of natural origin, and/or preferably carrying a low-concern precautionary statement; and
at least one additional excipient selected from anionic polyelectrolyte polymer surfactants, non-ionic surfactants, cationic surfactants, and any combination thereof;
   the anionic polyelectrolyte polymer surfactants being selected from sulfonates, and any combination thereof; the nonionic surfactants being selected from ethoxylated alcohols, and any combination thereof; the cationic surfactants being selected from organo-mineral polymers, and any combination thereof;
   said additional excipient preferably being water-soluble; said additional excipient preferably being a phytosanitarily acceptable excipient, and/or preferably an essentially biobased excipient, and/or an essentially biodegradable excipient, and/or an excipient essentially of natural origin, and/or preferably carrying a low-concern precautionary statement.

The composition can be in liquid or solid form (such as powder, granules, tablets). Preferably, the composition is in solid form. Indeed, the Inventors have shown that the composition can be used effectively to protect and/or treat crops in either liquid or solid form. The composition can be applied to crops in liquid form, or in solid form (particularly in powder form). When the composition is applied in liquid form, it can be presented in liquid form directly ready for use, or to be diluted (concentrated form). When the composition is applied in liquid form, it can also be presented in solid form, in which case it can be diluted/dissolved/solubilized in a suitable solvent prior to use (e.g., extemporaneously, or for short, medium or long-term storage prior to use). The composition has antifungal efficacy whatever its form.

In particular, the Inventors have shown that the composition is particularly stable and suitable for medium- to long-term storage in this form. According to a preferred embodiment, the composition according to the invention is in solid form, preferably in the form of a powder, tablets, granules, or any combination thereof. Even more preferably, the composition is in the form of a powder or granules, or any combination thereof.

According to an advantageous embodiment of the composition (in solid or liquid form, in particular of the composition in solid form):
the potassium bicarbonate content ranges from 5% to 90% by weight relative to the total weight of the composition, preferably from 10% to 90%, more preferably from 15% to 85%, more preferably from 20% to 80%, more preferably from 40% to 70%, most preferably from 50 to 65% by weight relative to the total weight of the composition; and/or
the content of anionic surfactants belonging to the taurate family ranges from 0.1% to 30% by weight relative to the total weight of the composition, preferably from 0.5% to 20%, preferably from 1% to 15%, more preferably from 2% to 10%, more preferably from 3% to 6%, by weight relative to the total weight of the composition.

According to an advantageous embodiment of the composition (in solid or liquid form, preferably the composition is a solid composition, advantageously a powder, granules, tablets or any combination thereof):
the potassium bicarbonate content ranges from 5% to 90% by weight relative to the total weight of the composition, preferably from 10% to 90%, preferably from 15% to 85%, preferably from 20% to 80%, preferably from 25% to 75%, preferably from 30% to 70%, preferably from 35% to 70%, preferably from 40% to 65%, preferably from 45% to 65%, preferably from 50% to 60%, by weight relative to the total weight of the composition; even more preferably, the potassium bicarbonate content is around 55% by weight, relative to the total weight of the composition; and/or
the content of anionic surfactants belonging to the taurate family ranges from 0.1% to 30% by weight relative to the total weight of the composition, preferably from 0.5% to 25%, more preferably from 1% to 20%, more preferably from 1.5% to 15%, more preferably from 2% to 10%, more preferably from 2.5% to 8%, more preferably from 2.5% to 6.5%, more preferably from 3% to 6%, by weight relative to the total weight of the composition.

According to one embodiment, the composition is a liquid composition, preferably in the form of an aqueous solution, preferably in the form of a sprayable aqueous solution, even more preferably in the form of an aerosol. In particular, the liquid composition may be in concentrated form (e.g. dilutable before use, e.g. 20 times concentrated, or 15 times, 10 times, 8 times, 5 times, 4 times, 3 times or 2 times concentrated) or in ready-to-use form.

According to one embodiment, the composition is a liquid composition obtained by diluting (and/or dissolving and/or dissolving and/or solubilizing) the composition in solid form in a suitable solvent, preferably according to a suitable dilution factor (preferably so as to obtain the potassium bicarbonate contents detailed below).

Suitable solvents for diluting/dissolving/solubilizing the concentrated liquid composition and/or the solid composition may, for example, be selected from aqueous solvents, such as water, alcohols (in particular aqueous alcohols, e.g., ethanol), acids (in particular carboxylic acids, e.g., acetic acid), and any combination thereof, preferably water.

According to a preferred embodiment of the liquid composition (in particular for the ready-to-use liquid composition, possibly after dilution of a concentrated liquid composition or after solution of a solid composition), the potassium bicarbonate content ranges from 5 to 60 grams per liter of composition (g/L), preferably from 8 to 55 g/L, preferably from 10 to 50 g/L, preferably from 15 to 45 g/L, preferably from 20 to 40 g/L, preferably from 25 to 35 g/L, preferably from 28 to 33 g/L, more preferably from 30 to 35 g/L of composition. In fact, data shows that crop protection and/or treatment efficacy, particularly antifungal activity, is particularly high when potassium bicarbonate concentration ranges from 5 to 60 g/L, in the liquid composition applied to crops. The person skilled in the art knows how to determine the appropriate dilution factors in order to obtain a liquid composition with such potassium bicarbonate contents, from a concentrated liquid composition or a solid composition.

According to one embodiment of the composition in liquid form (preferably in the form of an aqueous composition), the potassium bicarbonate content ranges from 0.1% to 35% by weight relative to the total weight of the composition, preferably from 0.5% to 25%, more preferably from 1% to 20%, more preferably from 5% to 15%, by weight relative to the total weight of the composition; still more preferably, the potassium bicarbonate content is about 10% by weight relative to the total weight of the composition.

Potassium bicarbonate can come from any source or origin and/or be obtained by any suitable process known to the person skilled in the art. The composition is also effective when potassium bicarbonate is obtained from alcoholic fermentation, such as wine fermentation. Indeed, the Inventors have shown that potassium bicarbonate can be efficiently obtained from alcoholic fermentation, such as wine fermentation, in particular from the carbon dioxide released by alcoholic fermentation. In addition to its efficiency, this potassium bicarbonate production process developed by the Inventors is particularly interesting from an ecological point of view. Indeed, the production of potassium bicarbonate, a material of considerable economic and industrial interest, makes it possible to recover the gases produced during alcoholic fermentation, while limiting the release of carbon dioxide, a greenhouse gas which is detrimental to the ozone layer.

According to one embodiment, the potassium bicarbonate of the composition is obtained from an alcoholic fermentation, preferably a vegetable fermentation, preferably a wine fermentation, the potassium bicarbonate preferably being obtained by a process comprising the following steps (or consisting essentially of, or consisting of, the following steps):
a) capture of the carbon dioxide released by alcoholic fermentation;
b) bubbling of the carbon dioxide captured in step a) in a potassium carbonate solution to obtain potassium bicarbonate crystals, preferably under conditions of saturation of the solution;
c) optionally, extraction of the potassium bicarbonate crystals obtained in step b).

According to a preferred embodiment of the composition, at least one anionic surfactant belonging to the taurate family is selected from N-methyltaurates; preferably from sodium N-methyltaurates, ammonium N-methyltaurates, calcium N-methyltaurates, alkali metal N-methyltaurates, alkaline earth metal N-methyltaurates, and any combination thereof; even more preferably from sodium N-methyltaurates.

Advantageously, the anionic surfactant belonging to the taurate family is water-soluble.

The data obtained by the Inventors also show that the presence of at least one additional excipient selected from anionic polyelectrolyte polymer surfactants, non-ionic surfactants, cationic surfactants and clays further enhances the composition's antifungal efficacy, protection durability and resistance to leaching. Advantageously, the composition according to the invention therefore further comprises at least one additional excipient selected from anionic polyelectrolyte polymer surfactants, non-ionic surfactants, cationic surfactants, clays, and any combination thereof.

Data show that the durability of protection and resistance to leaching are particularly high when the composition also comprises an additional excipient selected from clays. The present invention therefore relates to a composition as defined above, further comprising at least one additional excipient selected from clays.

The present invention therefore relates to a composition as defined above, comprising, or consisting essentially of, or consisting of:
potassium bicarbonate;
at least one excipient selected from anionic surfactants belonging to the taurate family;
and
at least one additional excipient selected from anionic polyelectrolyte polymer surfactants, non-ionic surfactants, cationic surfactants and clays;
   said excipient preferably being a phytosanitarily acceptable excipient, and/or preferably an essentially biobased excipient, and/or an essentially biodegradable excipient, and/or an excipient essentially of natural origin, and/or preferably carrying a low-concern precautionary statement. Said additional excipient is preferably water-soluble.

Advantageously, the composition comprises at least one anionic polyelectrolyte polymer surfactant, preferably selected from sulfonates, and any combination thereof; the sulfonate being preferably selected from lignosulfonates; preferably selected from sodium lignosulfonates, ammonium lignosulfonates, calcium lignosulfonates, and any combination thereof; more preferably still from sodium lignosulfonates and any combination thereof. Indeed, the antifungal efficacy of the composition is particularly high when it comprises such an anionic surfactant.

According to one embodiment of the composition comprising at least one anionic polyelectrolyte polymer surfactant, the latter is preferably selected from sulfonates (such as lignosulfonates) and any combination thereof. Thus, according to this embodiment in which the composition comprises at least one anionic polyelectrolyte polymer surfactant, the anionic polyelectrolyte polymer surfactant is advantageously selected from sulfonates (such as lignosulfonates) and any combination thereof.

Advantageously, the composition comprises at least one non-ionic surfactant, preferably selected from ethoxylated alcohols, and any combination thereof; the ethoxylated alcohol being preferably selected from secondary ethoxylated alcohols; more preferably still selected from secondary ethoxylated C8-C18 alcohols and any combination thereof. Indeed, the antifungal efficacy of the composition is particularly high when it comprises such a non-ionic surfactant.

According to one embodiment of the composition comprising at least one non-ionic surfactant, the latter is preferably selected from ethoxylated alcohols (such as secondary ethoxylated alcohols) and any combination thereof. Thus, according to this embodiment in which the composition comprises at least one non-ionic surfactant, the non-ionic surfactant is advantageously selected from ethoxylated alcohols (such as secondary ethoxylated alcohols) and any combination thereof.

Advantageously, the composition comprises at least one cationic surfactant, preferably selected from organo-mineral polymers, and any combination thereof; the organo-mineral polymer being preferably selected from siloxanes; preferably selected from alkylsiloxanes; still preferably selected from polydimethylsiloxanes, and any combination thereof. Indeed, the antifungal efficacy of the composition is particularly high when it comprises such a cationic surfactant.

According to one embodiment of the composition comprising at least one cationic surfactant, the latter is preferably selected from organo-mineral polymers (such as siloxanes) and any combination thereof. Thus, according to this embodiment in which the composition comprises at least one cationic surfactant, the cationic surfactant is advantageously selected from organo-mineral polymers (such as siloxanes) and any combination thereof.

Advantageously, the composition comprises at least one clay, preferably selected from silicates, and any combination thereof; the clay being preferably selected from phyllosilicates, more preferably still selected from kaolinites, and any combination thereof. Indeed, the antifungal efficacy of the composition is particularly high when it comprises such a clay.

According to one embodiment of the composition comprising at least one clay, the latter is preferably selected from silicates (such as phyllosilicates) and any combination thereof. Thus, according to this embodiment in which the composition comprises at least one clay, the clay is advantageously selected from silicates (such as phyllosilicates) and any combination thereof.

According to a preferred embodiment, the additional excipient of the composition comprises at least one anionic polyelectrolyte polymer surfactant, at least one non-ionic surfactant, at least one cationic surfactant, and at least one clay; the anionic polyelectrolyte polymer surfactant, the non-ionic surfactant, the cationic surfactant, and the clay being as defined above. Indeed, the antifungal efficacy of the composition is particularly high when it comprises such a mixture of additional excipients.

According to one embodiment, the composition further comprises at least one ingredient selected from the group consisting of:
a solvent, preferably an (essentially) biobased solvent. The solvent is preferably selected from aqueous solvents, further preferably selected from water, aqueous alcohols (e.g., ethanol), carboxylic acids (e.g., acetic acid) and any combination thereof;
a preservative (e.g., selected from benzyl alcohol, dehydroacetic acid and any combination thereof), preferably an (essentially) biobased preservative;
an antioxidant (e.g., selected from chitosans, tocopherol (vitamin E) and any combination thereof), preferably an (essentially) biobased antioxidant;
a colorant, preferably an (essentially) biobased colorant; and
any combination thereof.

Advantageously, the ingredient selected from solvent, preservative, antioxidant, colorant and any combination thereof are essentially biodegradable, preferably said ingredient is biodegradable. Advantageously, the ingredient selected from solvent, preservative, antioxidant, colorant and any combination thereof are essentially of natural origin, preferably said ingredient is of natural origin.

According to one embodiment, the composition is a composition which can be in liquid form (concentrated or not), or solid form (concentrated or not), preferably in solid form, in which the additional excipient comprises, or consists essentially of, at least one anionic polyelectrolyte polymer surfactant, wherein the anionic polyelectrolyte polymer surfactant content ranges from 0.1% to 40% by weight, based on the total weight of the composition, preferably from 0.5% to 35%, preferably from 1% to 30%, preferably from 2% to 25%, preferably from 2.5% to 20%, preferably from 5% to 15%, preferably from 7% to 13%, preferably from 9% to 11%, most preferably about 10%, by weight, based on the total weight of the composition. The composition is advantageously in solid form.

Alternatively or in combination, the composition is one which can be in liquid form (concentrated or not), or solid form (concentrated or not), preferably in solid form, in which the additional excipient comprises, or consists essentially of, at least one non-ionic surfactant, wherein the non-ionic surfactant content ranges from 0.01% to 40% by weight relative to the total weight of the composition, preferably from 0.05% to 30%, preferably from 0.1% to 20%, preferably from 0.5% to 15%, preferably from 1% to 10%, preferably from 1% to 9%, preferably from 2% to 8%, preferably from 2.5% to 7.5%, by weight relative to the total weight of the composition. The composition is advantageously in solid form.

Alternatively or in combination, the composition is one which can be in liquid form (concentrated or not), or solid form (concentrated or not), preferably in solid form, wherein the additional excipient comprises, or consists essentially of, or consists of, at least one cationic surfactant, wherein the cationic surfactant content ranges from 0.001% to 30% by weight relative to the total weight of the composition, preferably from 0.01% to 20%, preferably from 0.05% to 10%, preferably from 0.1% to 5%, preferably from 0.2% to 4%, preferably from 0.3% to 3%, preferably from 0.4% to 2%, preferably from 0.5% to 1.5%, preferably about 1%, by weight relative to the total weight of the composition. The composition is advantageously in solid form.

Alternatively or in combination, the composition is a composition which can be in liquid form (concentrated or not), or solid form (concentrated or not), preferably in solid form, in which the additional excipient comprises, or consists essentially of, or consists of, at least one clay, in which the clay content ranges from 0.5% to 60% by weight relative to the total weight of the composition, preferably from 5% to 50%, more preferably from 10% to 40%, more preferably from 15% to 35%, more preferably from 20% to 30%, more preferably from 21% to 29%, more preferably from 22% to 28%, by weight relative to the total weight of the composition. The composition is advantageously in solid form.

Thus, according to one embodiment, the composition (solid or liquid, preferably solid) is characterized in that:
i. the anionic polyelectrolyte polymer surfactant content ranges from 0.1% to 40% by weight relative to the total weight of the composition, preferably from 0.5% to 30%, more preferably from 1% to 20%, more preferably from 2% to 18%, most preferably from 5% to 15%, by weight relative to the total weight of the composition; or
ii. the non-ionic surfactant content ranges from 0.01% to 40% by weight, based on the total weight of the composition, preferably from 0.05% to 30%, preferably from 0.1% to 20%, preferably from 0.5% to 15%, preferably from 1% to 10%, by weight, based on the total weight of the composition; or
iii. the cationic surfactant content ranges from 0.001% to 30% by weight relative to the total weight of the composition, preferably from 0.01% to 20%, preferably from 0.1% to 10%, preferably from 0.3% to 5%, preferably from 0.5% to 2.5%, by weight relative to the total weight of the composition; or
iv. the clay content ranges from 0.5% to 60% by weight relative to the total weight of the composition, preferably from 5% to 50%, more preferably from 10% to 40%, more preferably from 15% to 35%, more preferably from 20% to 30%, by weight relative to the total weight of the composition; or
v. the additional excipient content is any combination of at least two characteristics selected from i to iv.

The Inventors have surprisingly shown that a composition comprising potassium bicarbonate, at least one excipient selected from anionic surfactants belonging to the taurate family, and at least one additional excipient selected from anionic polyelectrolyte polymer surfactants, non-ionic surfactants, cationic surfactants, clays, and any combination thereof, enables the growth of phytopathogenic fungi, in particular powdery mildew, downy mildew and rot of vines and/or cucurbits and/or solanaceous plants, to be strongly inhibited with high efficacy. Thus, according to a preferred embodiment, the composition (in particular the solid composition) comprises, or consists essentially of, or consists of:
potassium bicarbonate, preferably in a content ranging from 5% to 90% by weight relative to the total weight of the composition, preferably from 10% to 90%, preferably from 15% to 85%, preferably from 20% to 80%, preferably from 25% to 75%, preferably from 30% to 70%, preferably from 35% to 70%, preferably from 40% to 65%, preferably from 45% to 65%, preferably from 50% to 60%, by weight relative to the total weight of the composition; even more preferably, the potassium bicarbonate content is about 55% by weight, based on the total weight of the composition;
at least one anionic surfactant belonging to the taurate family, preferably in a content ranging from 0.1% to 30% by weight relative to the total weight of the composition, preferably from 0.5% to 25%, preferably from 1% to 20%, preferably from 1.5% to 15%, preferably from 2% to 10%, preferably from 2.5% to 8%, preferably from 2.5% to 6.5%, more preferably from 3% to 6%, by weight relative to the total weight of the composition;
optionally, at least one anionic polyelectrolyte polymer surfactant, preferably in an amount ranging from 0.1% to 40% by weight relative to the total weight of the composition, preferably from 0.5% to 35%, preferably from 1% to 30%, preferably from 2% to 25%, preferably from 2.5% to 20%, preferably from 5% to 15%, preferably from 7% to 13%, preferably from 9% to 11%, preferably about 10%, by weight relative to the total weight of the composition;
optionally, at least one non-ionic surfactant, preferably in an amount ranging from 0.01% to 40% by weight relative to the total weight of the composition, preferably from 0.05% to 30%, preferably from 0.1% to 20%, preferably from 0.5% to 15%, preferably from 1% to 10%, preferably from 1% to 9%, preferably from 2% to 8%, preferably from 2.5% to 7.5%, by weight relative to the total weight of the composition;
optionally, at least one cationic surfactant, preferably in an amount ranging from 0.001% to 30% by weight relative to the total weight of the composition, preferably from 0.01% to 20%, preferably from 0.05% to 10%, preferably from 0.1% to 5%, preferably from 0.2% to 4%, preferably from 0.3% to 3%, preferably from 0.4% to 2%, preferably from 0.5% to 1.5%, preferably about 1%, by weight relative to the total weight of the composition;
optionally, at least one clay, preferably in an amount ranging from 0.5% to 60% by weight relative to the total weight of the composition, preferably from 5% to 50%, preferably from 10% to 40%, preferably from 15% to 35%, preferably from 20% to 30%, preferably from 21% to 29%, preferably from 22% to 28%, by weight relative to the total weight of the composition; and
optionally, at least one solvent (preferably essentially biobased), preferably water.

According to a particularly preferred embodiment, the composition (in particular the solid composition) comprises, or consists essentially of, or consists of:
potassium bicarbonate, preferably in a content ranging from 5% to 90% by weight relative to the total weight of the composition, preferably from 10% to 90%, preferably from 15% to 85%, preferably from 20% to 80%, preferably from 25% to 75%, preferably from 30% to 70%, preferably from 35% to 70%, preferably from 40% to 65%, preferably from 45% to 65%, preferably from 50% to 60%, by weight relative to the total weight of the composition; even more preferably, the potassium bicarbonate content is around 55% by weight, based on the total weight of the composition;
at least one anionic surfactant belonging to the taurate family, preferably in a content ranging from 0.1% to 30% by weight relative to the total weight of the composition, preferably from 0.5% to 25%, preferably from 1% to 20%, preferably from 1.5% to 15%, preferably from 2% to 10%, preferably from 2.5% to 8%, preferably from 2.5% to 6.5%, preferably from 3% to 6%, by weight relative to the total weight of the composition;
at least one anionic polyelectrolyte polymer surfactant, preferably in an amount ranging from 0.1% to 40% by weight, based on the total weight of the composition, preferably from 0.5% to 35%, preferably from 1% to 30%, preferably from 2% to 25%, preferably from 2.5% to 20%, preferably from 5% to 15%, preferably from 7% to 13%, preferably from 9% to 11%, most preferably around 10%, by weight, based on the total weight of the composition;
at least one non-ionic surfactant, preferably in an amount ranging from 0.01% to 40% by weight relative to the total weight of the composition, preferably from 0.05% to 30%, preferably from 0.1% to 20%, preferably from 0.5% to 15%, preferably from 1% to 10%, preferably from 1% to 9%, preferably from 2% to 8%, preferably from 2.5% to 7.5%, by weight relative to the total weight of the composition;
at least one cationic surfactant, preferably in an amount ranging from 0.001% to 30% by weight relative to the total weight of the composition, preferably from 0.01% to 20%, preferably from 0.05% to 10%, preferably from 0.1% to 5%, preferably from 0.2% to 4%, preferably from 0.3% to 3%, preferably from 0.4% to 2%, preferably from 0.5% to 1.5%, preferably about 1%, by weight relative to the total weight of the composition; and
at least one clay, preferably in an amount ranging from 0.5% to 60% by weight, based on the total weight of the composition, preferably from 5% to 50%, preferably from 10% to 40%, preferably from 15% to 35%, preferably from 20% to 30%, preferably from 21% to 29%, preferably from 22% to 28%, by weight, based on the total weight of the composition;
and optionally, at least one solvent (preferably essentially biobased), preferably water.

According to a particularly advantageous embodiment, the various ingredients listed above (potassium bicarbonate, anionic surfactant belonging to the taurate family, anionic polyelectrolyte polymer surfactant, non-ionic surfactant, cationic surfactant, clay, solvent) are essentially biodegradable, preferably biodegradable. Advantageously, the various ingredients listed above (potassium bicarbonate, anionic surfactant belonging to the taurate family, anionic polyelectrolyte polymer surfactant, non-ionic surfactant, cationic surfactant, clay, solvent) are essentially of natural origin, preferably they are of natural origin.

The composition according to the invention (in solid or liquid form) may further comprise an additional excipient. The additional excipient may, for example, be glycerol. The composition according to the invention is preferably essentially glycerol-free, more preferably glycerol-free, more preferably glycerol-free. In fact, data show that the antifungal effect of the glycerol-free composition is superior to that of a composition comprising glycerol.

Advantageously, the composition is characterized in that it is suitable for phytosanitary use, preferably for antifungal use, preferably for antifungal use in the agricultural field, even more preferably for antifungal use in the viticultural field. Advantageously, the composition is characterized in that it has a phytosanitary effect/activity, preferably an antifungal effect/activity, preferably an antifungal effect/activity in the agricultural field, even more preferably an antifungal effect/activity in the viticultural field.

According to one embodiment, the composition is characterized in that it is a phytosanitary composition, preferably an antifungal composition.

Advantageously, the composition is characterized in that it comprises less than 25% of ingredients of non-natural origin, preferably less than 20%, preferably less than 15%, preferably less than 10%, preferably less than 9%, preferably less than 8%, preferably less than 7%, preferably less than 6%, preferably less than 5%, preferably less than 4%, preferably less than 3%, preferably less than 2%, preferably less than 1%, preferably less than 0.5%, preferably less than 0.1% of ingredients of non-natural origin; even more preferably, the composition is essentially free of ingredients of non-natural origin; even more preferably, the composition is essentially composed of ingredients of natural origin, said ingredients of natural origin preferably being biodegradable and/or carrying a low-concern precautionary statement and/or being biobased.

Advantageously, the composition is characterized in that it comprises at least 80% of biobased ingredients, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, preferably at least 99%, preferably at least 99.5%, preferably at least 99.9% of biobased ingredients; even more preferably, the composition is essentially composed of biobased ingredients, said biobased ingredients preferably being of natural origin; even more preferably, the composition is essentially free of non-biobased ingredients.

Advantageously, the composition is characterized in that it comprises at least 80% biodegradable ingredients, preferably at least 85%, preferably at least 90%, preferably at least 91%, preferably at least 92%, preferably at least 93%, preferably at least 94%, preferably at least 95%, preferably at least 96%, preferably at least 97%, preferably at least 98%, preferably at least 99%, preferably at least 99.5%, preferably at least 99.9% biodegradable ingredients; even more preferably, the composition is essentially composed of biodegradable ingredients, said biodegradable ingredients preferably being of natural origin; even more preferably, the composition is essentially free of non-biodegradable ingredients and/or the composition is essentially free of non-biobased ingredients.

According to a preferred embodiment, the composition is characterized in that it is essentially composed of biodegradable and/or natural and/or low-concern and/or biobased ingredients, said ingredients preferably being of natural origin.

Advantageously, the composition is obtained by a process comprising mixing the various ingredients.

The present invention also relates to a kit comprising:
potassium bicarbonate in a first container,
at least one excipient selected from anionic surfactants belonging to the taurate family in a second container; and
optionally, in a third container, at least one additional excipient selected from anionic polyelectrolyte polymer surfactants, non-ionic surfactants, cationic surfactants, and any combination thereof,
   potassium bicarbonate, the excipient and the additional excipient being as defined above in relation to the composition.

The present invention also relates to a kit comprising:
potassium bicarbonate in a first container,
at least one excipient selected from anionic surfactants belonging to the taurate family in a second container; and
optionally, in a third container, at least one additional excipient selected from anionic polyelectrolyte polymer surfactants, non-ionic surfactants, cationic surfactants, clays, and any combination thereof,
   potassium bicarbonate, excipient and additional excipient being as defined above in connection with the composition.

The present invention also relates to a kit comprising:
potassium bicarbonate in a first container,
at least one excipient selected from anionic surfactants belonging to the taurate family in a second container; and
in a third container, at least one additional excipient selected from anionic polyelectrolyte polymer surfactants, non-ionic surfactants, cationic surfactants, and any combination thereof,
optionally, in a fourth container, at least one additional excipient selected from clays,
   potassium bicarbonate, the excipient, additional excipient and further excipient being as defined above in relation to the composition.

Advantageously, the potassium bicarbonate and the at least one excipient selected from anionic surfactants belonging to the taurate family are in the same container (first container=second container). Alternatively, potassium bicarbonate and the at least one additional excipient are in the same container (first container=third container). Alternatively, the at least one excipient selected from anionic surfactants belonging to the taurate family and the at least one additional excipient are in the same container (second container=third container).

Advantageously, the kit includes instructions (or a guide) for use.

The present invention also relates to a kit comprising:
the composition as defined above (for example in liquid or solid form), in a first container;
and
at least one additional ingredient in a second container, said ingredient being selected from the group consisting of:
   a solvent, preferably a (substantially) biobased solvent. The solvent is preferably selected from aqueous solvents, further preferably selected from water, aqueous alcohols (e.g., ethanol), carboxylic acids (e.g. acetic acid) and any combination thereof;
   a preservative (e.g., selected from benzyl alcohol, dehydroacetic acid and any combination thereof), preferably an (essentially) biobased preservative;
   an antioxidant (e.g., selected from chitosans, tocopherol (vitamin E) and any combination thereof), preferably an (essentially) biobased preservative;
   a colorant, preferably an (essentially) biobased colorant; and
   any combination thereof.

Advantageously, the ingredient selected from solvent, preservative, antioxidant, colorant and any combination thereof are essentially biodegradable, preferably said ingredient is biodegradable. Advantageously, the ingredient selected from solvent, preservative, antioxidant, colorant and any combination thereof are essentially of natural origin, preferably said ingredient is of natural origin. Advantageously, the additional ingredient is a solvent. In particular, this configuration makes it possible to prepare a ready-to-use liquid composition, for example by diluting the composition in the first container, in concentrated liquid form or in solid form.

### Use

The Inventors have shown that a composition comprising potassium bicarbonate and at least one excipient selected from anionic surfactants belonging to the taurate family (said excipient preferably being a phytosanitarily acceptable excipient, and/or preferably an excipient of essentially biobased origin, and/or preferably an excipient of natural origin, and/or preferably carrying a low-concern precautionary statement), enables crops, in particular vines, cucurbits and solanaceous plants, to be protected and/or treated effectively. Surprisingly, the Inventors have demonstrated that such a composition has a significant antifungal effect, enabling the growth of phytopathogenic fungi to be strongly inhibited. Thus, the data in the Examples below show that, unexpectedly, application of this composition makes it possible to protect and/or treat crops (such as vines, cucurbits and solanaceous plants) against phytopathogenic fungi, in particular powdery mildew, downy mildew and rot of vines and/or cucurbits and/or solanaceous plants with high efficacy. The Inventors have also shown that, surprisingly, this new formulation exhibits a significant improvement in adhesion, spreading, resistance to leaching and longevity properties on vine, cucurbit and solanaceous leaves. The Inventors have also demonstrated a long-lasting, leaching protective effect. As a result, the frequency of treatment applications can be kept to a minimum, limiting costs and environmental impact. The data also show that such a composition is not phytotoxic to crops.

The present invention therefore relates to the use of a composition comprising, or consisting essentially of, or consisting essentially of, or consisting of:
potassium bicarbonate; and
at least one excipient selected from anionic surfactants belonging to the taurate family, said excipient preferably being a phytosanitarily acceptable excipient, and/or preferably an essentially biobased excipient;
   for treating and/or protecting crops, preferably vines, cucurbits, solanaceous plants (preferably potatoes), and any combination thereof, again preferably vines.

The present invention further relates to the use of a composition comprising, or consisting essentially of, or consisting of:
potassium bicarbonate;
at least one excipient selected from anionic surfactants belonging to the taurate family, said excipient preferably being a phytosanitarily acceptable excipient, and/or preferably an essentially biobased excipient, and/or an excipient of natural origin, and/or preferably carrying a low-concern precautionary statement; and
at least one additional excipient selected from anionic polyelectrolyte polymer surfactants, non-ionic surfactants, cationic surfactants, and any combination thereof;
   for treating and/or protecting crops, preferably vines, cucurbits, Solanaceae (preferably potatoes), and any combination thereof, more preferably vines; the anionic polyelectrolyte polymer surfactants being preferably selected from sulfonates, and any combination thereof; the nonionic surfactants being preferably selected from ethoxylated alcohols, and any combination thereof; the cationic surfactants being preferably selected from organo-mineral polymers, and any combination thereof;
   said additional excipient preferably being water-soluble; said additional excipient preferably being a phytosanitarily acceptable excipient, and/or preferably an essentially biobased excipient, and/or an excipient of natural origin, and/or preferably carrying a low-concern precautionary statement.

The present invention also relates to the use of a composition comprising, or consisting essentially of, or consisting of:
potassium bicarbonate;
at least one excipient selected from anionic surfactants belonging to the taurate family, said excipient preferably being a phytosanitarily acceptable excipient, and/or preferably an essentially biobased excipient, and/or an excipient of natural origin, and/or preferably carrying a low-concern precautionary statement; and
at least one additional excipient selected from anionic polyelectrolyte polymer surfactants, non-ionic surfactants, cationic surfactants, and any combination thereof;
   for treating and/or protecting crops, preferably vines, cucurbits, Solanaceae (preferably potatoes), and any combination thereof, more preferably vines; the anionic polyelectrolyte polymer surfactants being selected from sulfonates, and any combination thereof; the nonionic surfactants being selected from ethoxylated alcohols, and any combination thereof; the cationic surfactants being selected from organo-mineral polymers, and any combination thereof; said additional excipient preferably being water-soluble; said additional excipient preferably being a phytosanitarily acceptable excipient, and/or preferably an essentially biobased excipient, and/or an excipient of natural origin, and/or preferably carrying a low-concern precautionary statement.

The present invention further relates to the use of a composition comprising, or consisting essentially of, or consisting of:
potassium bicarbonate;
at least one excipient selected from anionic surfactants belonging to the taurate family, said excipient preferably being a phytosanitarily acceptable excipient, and/or preferably an essentially biobased excipient, and/or an excipient of natural origin, and/or preferably carrying a low-concern precautionary statement; and
at least one additional excipient selected from anionic polyelectrolyte polymer surfactants, non-ionic surfactants, cationic surfactants, clays, and any combination thereof;
   for treating and/or protecting crops, preferably vines, cucurbits, Solanaceae (preferably potatoes), and any combination thereof, more preferably vines; the anionic polyelectrolyte polymer surfactants being selected preferably from sulfonates, and any combination thereof; the non-ionic surfactants being preferably selected from ethoxylated alcohols, and any combination thereof; the cationic surfactants being preferably selected from organo-mineral polymers, and any combination thereof, the clays being preferably selected from silicates, and any combination thereof;
   said additional excipient preferably being water-soluble; said additional excipient preferably being a phytosanitarily acceptable excipient, and/or preferably an essentially biobased excipient, and/or an excipient of natural origin, and/or preferably carrying a low-concern precautionary statement.

The present invention relates in particular to the use of a composition as defined above (especially in the “Definitions” and “Composition” sections above) to treat and/or protect crops, preferably vines, cucurbits, Solanaceae (preferably potatoes), and any combination thereof, again preferably vines.

The composition can be used in liquid or solid form (such as powder, granules, tablets, or any combination thereof). Indeed, the Inventors have shown that the composition can be used effectively to protect and/or treat crops in either liquid or solid form. The composition can be applied to crops in liquid form, or in solid form (particularly in powder form). When the composition is applied in liquid form, it can be presented in liquid form directly ready for use, or to be diluted (for a composition in concentrated form). It can also be presented in solid form, in which case it can be diluted in a suitable solvent before use (e.g., extemporaneously, or for short, medium or long-term storage before use). In particular, the liquid composition can be presented in concentrated form (which can, for example, be diluted before use, e.g., 20 times concentrated, or 15 times, 10 times, 8 times, 5 times, 4 times, 3 times or 2 times concentrated) or in ready-to-use form. The composition has antifungal efficacy whatever its form.

When the composition is used in liquid form (in particular for ready-to-use liquid composition, possibly after dilution of a concentrated liquid composition or after solution of a solid composition), the potassium bicarbonate content ranges from 5 to 60 grams per liter of composition (g/L), preferably from 8 to 55 g/L, preferably from 10 to 50 g/L, preferably from 15 to 45 g/L, preferably from 20 to 40 g/L, preferably from 25 to 35 g/L, preferably from 28 to 33 g/L, preferably from 30 to 35 g/L of applied composition. In fact, data show that crop protection and/or treatment efficacy, particularly antifungal activity, is particularly high when the potassium bicarbonate concentration ranges from 5 to 60 g/L, in the liquid composition applied to the crops.

According to one embodiment, the composition is used in the form of an aqueous solution, preferably in the form of a sprayable aqueous solution, even more preferably in the form of an aerosol. Advantageously, the composition is applied to crops by spraying and/or vaporization and/or projection. Thus, the composition can be sprayed and/or vaporized and/or projected onto the crops.

According to one embodiment, the use is characterized in that the composition is applied to the crops before or after harvesting said crops, preferably by spraying and/or vaporizing and/or projecting. Thus, the use of the composition comprises, or consists of, or consists essentially of, the application of the composition to the crops, before or after harvesting said crops.

According to one embodiment, the composition further comprises at least one additional excipient selected from anionic polyelectrolyte polymer surfactants, non-ionic surfactants, cationic surfactants, clays, and any combination thereof; said additional excipient preferably being water-soluble (said additional excipient preferably being as defined above (particularly in the “Definitions” and “Composition” sections above).

Advantageously, the use is a phytosanitary use.

According to one embodiment, the use of the composition comprises, or consists of, or consists essentially of, the protection of crops (in particular vines, cucurbits, Solanaceae (preferably potatoes), and any combination thereof, again preferably vines) against pathogenic fungi and/or fungal diseases.

According to one embodiment, the use of the composition comprises, or consists of, or consists essentially of, the treatment of crops (in particular vines, cucurbits, solanaceous plants (preferably potatoes), and any combination thereof, again preferably vines) against pathogenic fungi and/or fungal diseases.

According to one embodiment, the use of the composition comprises, or consists of, or consists essentially of, the protection and/or treatment of crops (in particular vines, cucurbits, solanaceous plants (preferably potatoes), and any combination thereof, again preferably vines) against pathogenic fungi and/or fungal diseases.

Alternatively, or in combination, the use of the composition comprises, or consists of, or consists essentially of, the control of pathogenic fungi and/or fungal diseases on crops (in particular vines, cucurbits, Solanaceae (preferably potatoes), and any combination thereof, more preferably vines). According to one embodiment, the use is for treating and/or protecting crops (in particular vines, cucurbits, Solanaceae (preferably potatoes), and any combination thereof, again preferably vines) and/or controlling the fungal pathogen and/or fungal disease growth on crops (in particular vines, cucurbits, Solanaceae (preferably potatoes), and any combination thereof, again preferably vines). According to an embodiment, the pathogenic fungus is selected from phytopathogenic fungi, in particular from vine downy mildew (Plasmopara viticola), vine powdery mildew (Uncinula necator and/or Erysiphe necator), vine rot (Botrytis cinerea), solanaceous downy mildew (Phytophthora parasitica and/or Phytophtora infestans), cucurbit downy mildew (Pseudoperonospora cubensis) and any combination thereof, preferably vine downy mildew (Plasmopara viticola).

The present invention also relates to the use of a kit as defined above to treat and/or protect crops, preferably vines, cucurbits, Solanaceae (preferably potatoes), and any combination thereof; more preferably vines. The present invention also relates to the use of a composition obtained (or capable of being obtained, or directly obtained) by means of the kit as defined above to treat and/or protect crops, preferably vines, cucurbits, solanaceous plants (preferably potatoes), and any combination thereof; again, preferably vines. Advantageously, the use of a kit and a composition obtained (or capable of being obtained, or directly obtained) by means of the kit is as defined above in relation to the composition.

### Method

The present invention relates to a method of protecting and/or treating crops, comprising the application of a composition as defined above, or a composition prepared from the kit as defined above (in particular a composition obtained, or capable of being obtained, or directly obtained by means of the kit), to the crops to be protected and/or treated, wherein the crops are preferably vines, cucurbits, Solanaceae (preferably potatoes), and any combination thereof; more preferably vines.

The present invention therefore relates to a method of protecting and/or treating crops, comprising the application (to the crops to be treated or in the vicinity of said crops) of a composition comprising, or consisting essentially of, or consisting essentially of, or consisting of:
potassium bicarbonate; and
at least one excipient selected from anionic surfactants belonging to the taurate family, said excipient preferably being a phytosanitarily acceptable excipient, and/or preferably an essentially biobased excipient, and/or an excipient of natural origin, and/or preferably carrying a low-concern precautionary statement;
   crops preferably including vines, cucurbits, solanaceous plants (preferably potatoes), and any combination thereof; also, preferably vines.

The present invention further relates to a method of protecting and/or treating crops, comprising the application (to the crops to be treated or in the vicinity of said crops) of a composition comprising, or consisting essentially of, or consisting of:
potassium bicarbonate;
at least one excipient selected from anionic surfactants belonging to the taurate family, said excipient preferably being a phytosanitarily acceptable excipient, and/or preferably an essentially biobased excipient, and/or an excipient of natural origin, and/or preferably carrying a low-concern precautionary statement; and
at least one additional excipient selected from anionic polyelectrolyte polymer surfactants, non-ionic surfactants, cationic surfactants, and any combination thereof;
   the anionic polyelectrolyte polymer surfactants being preferably selected from sulphonates, and any combination thereof; the non-ionic surfactants being preferably selected from ethoxylated alcohols, and any combination thereof; the cationic surfactants being preferably selected from organo-mineral polymers, and any combination thereof;
   said additional excipient preferably being water-soluble; said additional excipient preferably being a phytosanitarily acceptable excipient, and/or preferably an essentially biobased excipient, and/or an excipient of natural origin, and/or preferably carrying a low-concern precautionary statement;
   crops, preferably including vines, cucurbits, solanaceous plants (preferably potatoes), and any combination thereof; also, preferably vines.

The present invention also relates to a method of protecting and/or treating crops, comprising the application (to the crops to be treated or in the vicinity of said crops) of a composition comprising, or consisting essentially of, or consisting of:
potassium bicarbonate;
at least one excipient selected from anionic surfactants belonging to the taurate family, said excipient preferably being a phytosanitarily acceptable excipient, and/or preferably an essentially biobased excipient, and/or an excipient of natural origin, and/or preferably carrying a low-concern precautionary statement; and
at least one additional excipient selected from anionic polyelectrolyte polymer surfactants, non-ionic surfactants, cationic surfactants, and any combination thereof;
   the anionic polyelectrolyte polymer surfactants being selected from sulfonates, and any combination thereof; the nonionic surfactants being selected from ethoxylated alcohols, and any combination thereof; the cationic surfactants being selected from organo-mineral polymers, and any combination thereof;
   said additional excipient preferably being water-soluble; said additional excipient preferably being a phytosanitarily acceptable excipient, and/or preferably an essentially biobased excipient, and/or an excipient of natural origin, and/or preferably carrying a low-concern precautionary statement;
   crops preferably including vines, cucurbits, Solanaceae (preferably potatoes), and any combination thereof; more preferably vines.

The present invention further relates to a method of protecting and/or treating crops, comprising the application (to the crops to be treated or in the vicinity of said crops) of a composition comprising, or consisting essentially of, or consisting of:
potassium bicarbonate;
at least one excipient selected from anionic surfactants belonging to the taurate family, said excipient preferably being a phytosanitarily acceptable excipient, and/or preferably an essentially biobased excipient, and/or an excipient of natural origin, and/or preferably carrying a low-concern precautionary statement; and
at least one additional excipient selected from anionic polyelectrolyte polymer surfactants, non-ionic surfactants, cationic surfactants, clays, and any combination thereof;
   the anionic polyelectrolyte polymer surfactants being preferably selected from sulphonates, and any combination thereof; the non-ionic surfactants being preferably selected from ethoxylated alcohols, and any combination thereof; the cationic surfactants being preferably selected from organo-mineral polymers, and any combination thereof, the clays being preferably selected from silicates, and any combination thereof;
   the anionic polyelectrolyte polymer surfactants being preferably selected from sulphonates, and any combination thereof; the non-ionic surfactants being preferably selected from ethoxylated alcohols, and any combination thereof; the cationic surfactants being preferably selected from organo-mineral polymers, and any combination thereof, the clays being preferably selected from silicates, and any combination thereof;

The present invention relates in particular to a method for treating and/or protecting crops, preferably vines, cucurbits, Solanaceae (preferably potatoes), and any combination thereof; more preferably vines, comprising the application of a composition as defined above (in particular in the “Definitions” and “Composition” sections above).

The Inventors have shown that the composition can be used effectively to protect and/or treat crops in either liquid or solid form. The composition can therefore be applied to crops in liquid form, or in solid form (particularly in powder form). When the composition is applied in liquid form, it can be presented in liquid form directly ready for use, or to be diluted (concentrated form). It can also be presented in solid form, in which case it can be diluted in a suitable solvent before application (e.g., extemporaneously, or for short, medium or long-term storage before use). In particular, the liquid composition can be presented in concentrated form (which can, for example, be diluted before use, e.g., 20 times concentrated, or 15 times, 10 times, 8 times, 5 times, 4 times, 3 times or 2 times concentrated) or in ready-to-use form. The composition has antifungal efficacy whatever its form.

When the composition is used in liquid form (in particular for ready-to-use liquid composition, possibly after dilution of a concentrated liquid composition or after solution of a solid composition), the potassium bicarbonate content ranges from 5 to 60 grams per liter of composition (g/L), preferably from 8 to 55 g/L, preferably from 10 to 50 g/L, preferably from 15 to 45 g/L, preferably from 20 to 40 g/L, preferably from 25 to 35 g/L, preferably from 28 to 33 g/L, preferably from 30 to 35 g/L of applied composition. In fact, data show that crop protection and/or treatment efficacy, particularly antifungal activity, is particularly high when the potassium bicarbonate concentration ranges from 5 to 60 g/L, in the liquid composition applied to the crops.

According to one embodiment, the composition is applied in the form of an aqueous solution, preferably in the form of a sprayable aqueous solution, even more preferably in the form of an aerosol. Advantageously, the composition is applied to crops by spraying and/or vaporization and/or projection. Thus, the composition can be sprayed and/or vaporized and/or projected onto the crops. In this case, the method comprises a step of spraying and/or vaporizing and/or projecting the composition onto the crops.

According to one embodiment, the method is characterized in that the composition is applied to the crops before or after harvesting said crops, preferably by spraying and/or vaporization and/or projection. Thus, the method comprises, or consists of, or consists essentially of a step of applying the composition to the crops, before or after harvesting said crops.

Advantageously, the method is a phytosanitary method. The method can therefore be a phytosanitary treatment and/or protection and/or control method.

According to one embodiment, the method comprises, or consists of, or consists essentially of, protecting crops (in particular vines, cucurbits, solanaceous plants (preferably potatoes), and any combination thereof; more preferably vines) against pathogenic fungi and/or fungal diseases.

According to one embodiment, the method comprises, or consists of, or consists essentially of treating crops (in particular vines, cucurbits, solanaceous plants (preferably potatoes), and any combination thereof; more preferably vines) against pathogenic fungi and/or fungal diseases.

According to one embodiment, the method comprises, or consists of, or consists essentially of, protecting and/or treating crops (in particular vines, cucurbits, solanaceous plants (preferably potatoes), and any combination thereof; more preferably vines) against fungal pathogens and/or fungal diseases.

Alternatively, or in combination, the method comprises, or consists of, or consists essentially of the control of pathogenic fungi and/or fungal diseases on crops (in particular vines, cucurbits, Solanaceae (preferably potatoes), and any combination thereof; more preferably vines).

According to one embodiment, the method is for treating and/or protecting crops (in particular vines, cucurbits, Solanaceae (preferably potatoes), and any combination thereof; again, preferably vines) and/or controlling the fungal pathogen and/or fungal disease growth on crops (in particular vines, cucurbits, Solanaceae (preferably potatoes), and any combination thereof; again, preferably vines).

According to an embodiment, the pathogenic fungus is selected from phytopathogenic fungi, in particular from vine downy mildew (Plasmopara viticola), vine powdery mildew (Uncinula necator and/or Erysiphe necator), vine rot (Botrytis cinerea), solanaceous downy mildew (Phytophthora parasitica and/or Phytophtora infestans), cucurbit downy mildew (Pseudoperonospora cubensis) and any combination thereof, preferably vine downy mildew (Plasmopara viticola).

According to one embodiment, the pathogenic fungus is selected from phytopathogenic fungi, in particular from vine downy mildew (Plasmopara viticola), vine powdery mildew (Uncinula necator and/or Erysiphe necator), vine rot (Botrytis cinerea), solanaceous downy mildew (Phytophthora parasitica and/or Phytophtora infestans), cucurbit downy mildew (Pseudoperonospora cubensis) and any combination thereof, preferably vine downy mildew (Plasmopara viticola).

The present invention relates in particular to a method for protecting crops from pathogenic fungi and/or fungal diseases, for treating crops against pathogenic fungi and/or fungal diseases, for controlling pathogenic fungi and/or fungal diseases on crops, and to any combination thereof, comprising the application of a composition as defined above; wherein the crops are preferably vines, cucurbits, Solanaceae (preferably potatoes), and any combination thereof; more preferably vines.

The present invention also relates to a method for protecting and/or treating crops, comprising the following steps:
a) preparing a composition as defined above, comprising for example diluting the concentrated composition or the solid composition as defined above with a suitable solvent, and/or using the kit as defined above); and
b) applying the composition according to step a) to the cultures to be treated.

Advantageously, in step b), the composition of step a) is applied extemporaneously.

### DESCRIPTION OF FIGURES

FIG. 1: Growth inhibition curves for P. viticola strains A: PV221; B: PV1538-1; C: PV413-1, as a function of different concentrations of each of the 5 compositions tested (Products 1 to 5 of Example 2).

FIG. 2: Growth inhibition curves for P. viticola strains PV221; PV1538-1; PV413-1 as a function of different concentrations of each of the compositions 1 to 5 (Products 1 to 5 of Example 2, shown in panels A to E respectively).

FIG. 3: IC50 and MIC values obtained for each composition (Products 1 to 5 from Example 2) and each mildew strain (P. viticola).

FIG. 4: Mean IC50 and MIC values obtained for each composition (Products 1 to 5 from example 2).

FIG. 5: Growth inhibition curves for P. viticola strains PV221; PV1538-1; and PV413-1, as a function of different concentrations of each of the 6 compositions tested (Products 1 to 6 in Example 3).

FIG. 6: Growth inhibition curves for P. viticola strains PV221; PV1538-1; PV413-1 as a function of different concentrations of each of the compositions 1 to 6 (Products 1 to 6 from Example 3).

FIG. 7: IC50 and MIC values obtained for each composition (Products 1 to 6 from Example 3) and each mildew strain (P. viticola).

FIG. 8: Mean IC50 and MIC values obtained for each composition (Products 1 to 6 from example 3).

FIG. 9: Downy mildew growth inhibition curves observed on vine plants treated with the three doses (D1, D2 and D3) of the 4 products (Products 1 to 4 in Example 4) over time: just after the first treatment (DO-T1), 7 days after the first treatment (D7-T1), just after the second treatment (DO-T2) and 7 days after the second treatment (D7-T2).

FIG. 10: Downy mildew growth inhibition curves observed on vine plants treated with the average concentration (D2) of the 4 products over the course of the experiment.

FIG. 11: Area under the downy mildew growth inhibition progression curve (AUDPC) obtained during the trial. The growth inhibition curve data in FIG. 10 have been transformed into a single value. Values are means±SD of AUDPC obtained.

FIG. 12: Graphs showing the average percentage inhibition of fungal growth by products 1 to 4, compared with the control condition (sprayed with sterile water), after leaching. A) Fine leaching (rainfall: 25 mm for 4 hours). B) Heavy leaching (Thunderstorm: 20 mm in 20 minutes).

### EXAMPLES

### Example 1: Fine-Tuning Formulations

### Example 1: Fine-Tuning Formulations

As part of its overall environmental approach, Château Montrose is committed to green viticulture based on the principles of organic farming. Downy mildew is one of the most problematic diseases in the Bordeaux region, as it is located on the oceanic front (humid climate). To combat this disease organically, only copper is really effective. Moreover, in organic farming, only copper is authorized for use against downy mildew (Plasmopara viticola). Yet copper progressively contaminates and pollutes vineyard soils year after year, treatment after treatment. In addition, copper could be used for a maximum of 6 kg/ha/year until 2018, and, since 2019, for 4 kg/ha/year. As the status of copper and its use is reviewed every 5 years at European level, it seemed strategic to Château Montrose to anticipate a viticulture without recourse to this metal.

As part of its R&D activity, led by Vincent Decup, Château Montrose sought a solution that would eventually replace copper in whole or in part. It wanted to develop an alternative formula based on a by-product of its alcoholic fermentation, potassium bicarbonate. Potassium bicarbonate is already known to limit the development of powdery mildew (Erysiphe necator or Uncinula necator), downy mildew (Plasmopara viticola) and gray mold (Botrytis cinerea) in viticulture. However, aqueous potassium bicarbonate solutions have poor adhesion and spreading properties on treated vines (particularly on vine leaves) when no excipient is used. What's more, these solutions are easily leached by the weather (especially rainwater) when applied to treated fields. It would therefore be advantageous to have new bicarbonate compositions with optimized antifungal activity, better adhesion, better spreading, resistance to leaching and increased longevity on the leaves of vines, cucurbits and solanaceous plants, while being suitable for use in organic farming, particularly organic viticulture.

Château Montrose therefore first tested the effect of this molecule on downy mildew, powdery mildew and vine rot, both to validate its efficacy and verify its safety. The effect of potassium bicarbonate on these phytopathogens was significant, and at concentrations acceptable to the plant in terms of phytotoxicity. Château Montrose then decided to formulate this active ingredient in order to improve/optimize the product's efficacy. During this work, the aim was to find excipients/adjuvants to be added to potassium bicarbonate, capable of improving the product's spread on the leaf, its adhesion, and preventing it from being leached by rainwater when applied in the field. Only 100% biobased (derived from living organisms) compounds acceptable from a phytosanitary point of view were tested in the formulation process.

The general formula of the compositions (in solid or liquid form) tested is shown in Table 1.

TABLE 1
Phytosanitary antifungal composition tested (quantities are
given in % by weight based on total composition weight).

| Ingredient | weight %/total weight |
|---|---|
| Potassium bicarbonate KHCO₃ | 5-90% |
| Anionic surfactant belonging to the | 0.1-30% |
| taurate family | |
| Anionic polyelectrolyte polymer | 0.1-40% |
| surfactant | |
| Non-ionic surfactant | 0.01-40% |
| Cationic surfactant | 0.001-30% |
| Clay | 0.5-60% |
| Solvent (aqueous, e.g., water) | 0-90% |
| Total | 100% |

### 1.1. Active Ingredient: Potassium Bicarbonate

Château Montrose has developed a particularly ecologically interesting, yet highly efficient process for producing potassium bicarbonate. Château Montrose has shown that high-purity potassium bicarbonate can be obtained from alcoholic fermentation, such as wine fermentation. During alcoholic fermentation, such as the transformation of grapes into wine, carbon dioxide is released. In the process we've developed, this carbon dioxide is captured by a piping system and then conveyed to columns outside the winery, in which a potassium carbonate solution is present. As the carbon dioxide bubbles through the solution, it binds with the carbonate to form bicarbonate, which crystallizes when the medium is saturated. The powder thus formed is extracted in columns in 500 kg to 1 T bags.

Thanks to this process, Château Montrose was able to produce over 2 tons of potassium bicarbonate in 2018.

The potassium bicarbonate used in the compositions according to the invention can be obtained/produced by any suitable process. However, biobased potassium bicarbonate is preferred, in particular that obtained by alcoholic fermentation (as described above).

Thus, this process has the triple advantage of recovering the gases produced during wine fermentation, producing an industrially and economically important compound, and limiting the release of carbon dioxide, a greenhouse gas detrimental to the ozone layer.

### 1.2 Development of Solid-Form Compositions

### 1.2.1. Concentration of Active Ingredient (Potassium Bicarbonate)

Tests were carried out to determine the optimum concentration of potassium bicarbonate in a solid composition (such as a powder). The tests revealed that the optimum concentration of potassium bicarbonate ranges from 50% to 62% (approx.).

### 1.2.2. Choice of Excipients

Data show that anionic surfactants belonging to the taurate family (notably N-methyltaurates), anionic polyelectrolyte polymer surfactants (notably sulfonates), non-ionic surfactants (notably ethoxylated alcohols), cationic surfactants (notably organo-mineral polymers), and clays (notably silicates), are particularly suitable. Indeed, the compatibility of these excipients with potassium bicarbonate is optimal (data not shown).

### 1.2.3. Composition Optimization

The most favorable results are observed with the optimized compositions described in Table 2 below.

TABLE 2
Optimized compositions (quantities are given in % by weight relative to the total weight
of the composition in solid form).

| Composition ID | 20B14GR01 | 20F16GR01 | 20F17GR01 | 20F26WG01 | 20F29WG01 | 20G08WG01 | 20G09WG01 |
|---|---|---|---|---|---|---|---|
| Compound | % (by weight) | % (by weight) | % (by weight) | % (by weight) | % (by weight) | % (by weight) | % (by weight) |
| Ufoxane 3A | 10 | 10 | 10 | 10 | 10 | 10 | 10 |
| (lignosulfonate | | | | | | | |
| anionic | | | | | | | |
| polyelectrolyte | | | | | | | |
| polymer) | | | | | | | |
| Tergitol 15- | 7.5 | 5 | 5 | 2.5 | 2.5 | 4 | 2.5 |
| S-12 | | | | | | | |
| (ethoxylated | | | | | | | |
| alcohol non- | | | | | | | |
| ionic | | | | | | | |
| surfactant) | | | | | | | |
| Adinol OT-72 | 6 | 6 | 6 | 6 | 3 | 3 | 3 |
| (taurate | | | | | | | |
| anionic | | | | | | | |
| surfactant) | | | | | | | |
| Rhodorsil | 1 | 1 | 1 | 1 | 1 | 1 | 1 |
| EP6703 | | | | | | | |
| (PDMS | | | | | | | |
| cationic | | | | | | | |
| surfactant) | | | | | | | |
| Argirec B22 | 25.5 | 28 | 25.5 | 25.5 | 23.5 | 22 | 21.5 |
| (kaolinite | | | | | | | |
| clay) | | | | | | | |
| Potassium | 50 | 50 | 52.5 | 55 | 60 | 60 | 62 |
| bicarbonate | | | | | | | |
| (KHCO3) | | | | | | | |
| Total | 100 | 100 | 100 | 100 | 100 | 100 | 100 |
| Corresponding | Product 2 | Product 1 | Product 2 | Product 3 | Product 4 | Product 5 | Product 6 |
| Product | in | in | in | in | in | in | in |
| Number | example | example | example | example 3 | example 3 | example 3 | example 3 |
| | 2 below | 3 below | 3 below | below | below | below | below |

### Example 2: Superior Antifungal Activity of Compositions According to the Invention

### Compositions Tested:

Product 1: 20A20SL01
Product 2: 20B14GR02
Product 3: 20B17GR01
Product 4: 20B18GR01
Product 5: 2B14GR01+adjuvant (5% glycerine solution for 10% potassium bicarbonate).

Products 2 and 5 are compositions according to the invention, whose solid composition is given in table 2 above and recalled in table 3 below (the composition of product 5 is the same as that of product 2, except for the additional presence of an adjuvant).

Products 1, 3 and 4 are comparative products. Their composition is shown in Table 3 below.

TABLE 3
Compositions tested in Example 2 (quantities are given in % by
weight relative to the total weight of the solid or liquid composition).

| | Composition ID | | | |
|---|---|---|---|---|
| | Product 1: | Product 2: | Product 3: | Product 4: |
| | 20A20SL01 | 20B14GR01 | 20B17GR01 | 20B18GR01 |
| Compound | % (by weight) | % (by weight) | % (by weight) | % (by weight) |
| Ufoxane 3A | 0 | 10 | 10 | 10 |
| (lignosulfonate | | | | |
| anionic | | | | |
| polyelectrolyte | | | | |
| polymer) | | | | |
| Tergitol 15-S-12 | 1.5 | 7.5 | 0 | 5 |
| (ethoxylated alcohol | | | | |
| non-ionic surfactant) | | | | |
| Adinol OT-72 | 0 | 6 | 7.5 | 0 |
| (tensioactif anionique | | | | |
| taurate) | | | | |
| Rhodorsil EP6703 | 0 | 1 | 1 | 1 |
| (PDMS cationic | | | | |
| surfactant) | | | | |
| Argirec B22 (kaolinite | 0 | 25.5 | 31.5 | 31.5 |
| clay) | | | | |
| Potassium bicarbonate | 10 | 50 | 50 | 50 |
| (KHCO3) | | | | |
| Glycerin (glycerol) | 5 | 0 | 0 | 0 |
| Supragil MNS 90 | 0 | 0 | 0 | 7.5 |
| Water | 83.5 | 0 | 0 | 0 |
| Total | 100 | 100 | 100 | 100 |
| | Comparative | Composition | Comparative | Comparative |
| | composition | according to the | composition | composition |
| | | invention | | |

### 2.1. Objective

The objective of this trial was to evaluate the efficacy of five potassium bicarbonate-based formulations (Products 1-5) against phytopathogens, in particular downy mildew, and to define minimum inhibitory concentrations.

### 2.2. Materials and Methods

### 2.2.1. Plant Material

Production is carried out in the greenhouse, using leaf cuttings taken from shoots placed in pots of greenhouse-grown potting soil, with a photoperiod of 16 hours. The minimum time required to obtain plants with 4 to 5 well-developed leaves is around 4 weeks.

The third and fourth leaves from the apex of 2-month-old plants were used for the various tests. Laboratory experiments were carried out on 18 mm-diameter leaf discs.

### 2.2.2. Fungal Material

Downy mildew is a strict obligate pathogen, i.e., it cannot multiply in the absence of its host plant. The laboratory has a collection of single-spore strains from field collections, stored at −20° C. The strains used in these tests are those referenced under identifiers PV221, PV413-1, and PV1538-1. The tests were carried out on 18 mm-diameter leaf discs placed in the Petri dish, top side in contact with Whatman paper.

### 2.2.3. Methods: In Vitro Efficacy Tests

Different concentrations of product are applied to the leaf discs using an airbrush just prior to pathogen inoculation (extemporaneously). The discs are then air-dried for one hour.

Controls are performed by applying the same quantity of sterile distilled water to leaf discs.

Inoculation is carried out using a sporangia suspension prepared at between 5,000 and 10,000 sporangia/ml at a rate of 3 drops of 15 μl per leaf disc.

Treatment efficacy is determined by visual assessment of pathogen development after 7 days at 22° C.

Results are presented as the average percentage inhibition of fungal growth compared with the control modality, sprayed with sterile water, obtained by the following calculation:

% inhibition=100×1−(% growth “treated”/% growth “control”)

The value corresponding to the dose that inhibits 50% of fungal growth (IC50) and the minimum inhibitory concentration (MIC) are determined using graphical representations of the percentage inhibition as a function of product concentration, thus enabling a field-applicable dose to be set. Two independent experiments are carried out for each test.

### 2.3. Results

Tests were carried out on strains PV221, PV413-1 and PV1538-1, using 1 box of 8 treated leaf discs per modality and 6 different concentrations for each formulation tested (0 g/L, 0.35 g/L, 0.65 g/L, 1.25 g/L, 2.5 g/L, 5 g/L and 10 g/L).

### 2.3.1. Antifungal Activity

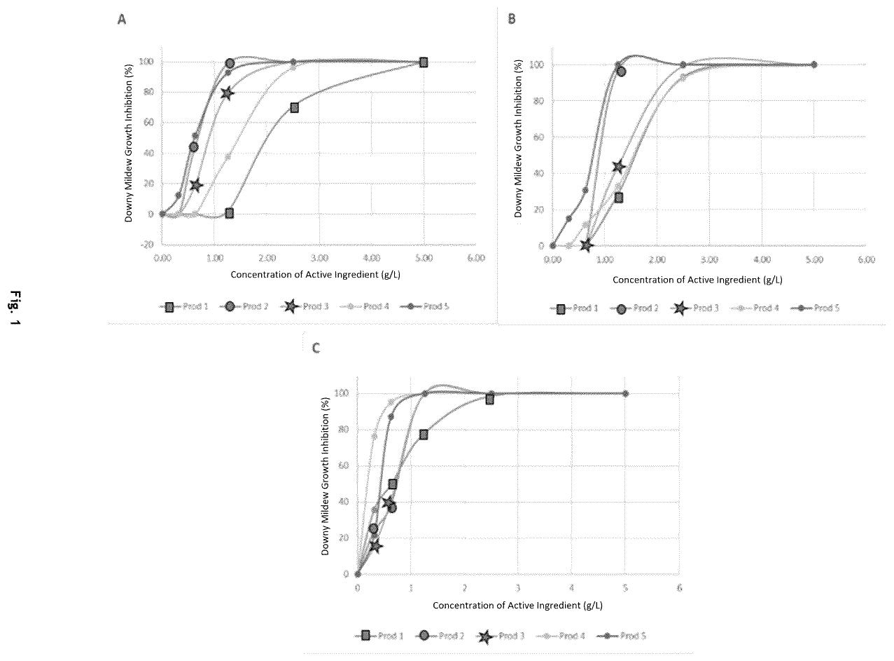

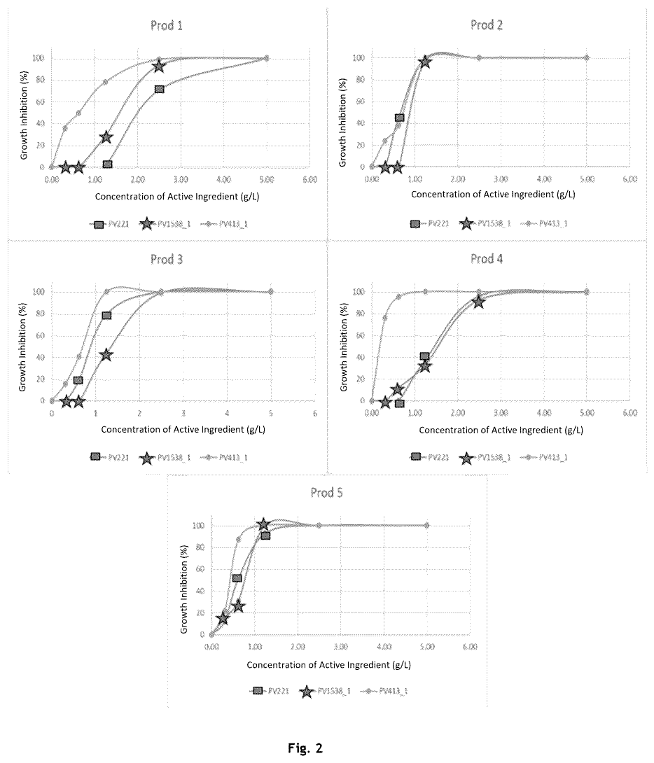

The results are shown in FIGS. 1 and 2. The data show that all five products tested are capable of inhibiting the growth of the different downy mildew strains tested. The data show that product efficacy can vary depending on the strain tested, but also on the composition tested.

Under the conditions tested, products 2 and 5 were more effective on PV221 and PV 1538-1 strains than products 1 and 4, with product 3 showing intermediate efficacy. Product 4 appears to be more effective than the others on the PV 413-1 strain (FIG. 1).

FIG. 2 shows the efficacy of each product. Importantly, products 2 and 5 are particularly active under the conditions tested, and show consistent efficacy across all strains.

Furthermore, the results obtained show a significant strain effect. Indeed, although the efficacy of the 5 formulations appears to be more homogeneous with strains PV-221 and PV1538-1, it is less so with strain PV413-1.

Products 2 and 5 show similar and particularly high efficiencies whatever the strain tested, whereas product 1 seems less effective against strain PV-221, and product 3 less effective against strain PV1538-1, under the conditions tested.

### 2.3.2. IC50 and MC Calculations

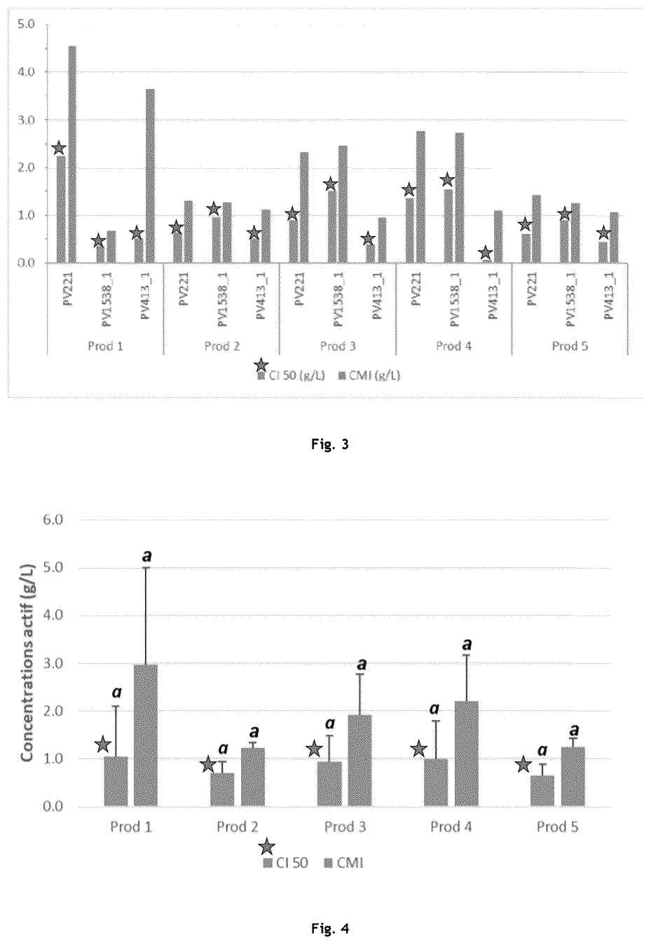

Based on the equations of the curves obtained (FIGS. 1 and 2), it is then possible to determine the IC50 values (values of x for which a value of 50 or 100 is obtained in y). The IC50 and MIC values obtained are shown in FIG. 3 and Table 4 below.

TABLE 4
IC50 and MIC values obtained for each composition tested and each downy mildew strain

| | Product 1 | | | Product 2 | | | Product 3 | | | Product 4 | | | Product 5 | | |
|---|---|---|---|---|---|---|---|---|---|---|---|---|---|---|---|
| | | PV1538- | PV | | PV1538- | PV | | PV1538- | PV | | PV1538- | PV | | PV1538- | PV |
| Strain | PV221 | 1 | 413-1 | PV221 | 1 | 413-1 | PV221 | 1 | 413-1 | PV221 | 1 | 413-1 | PV221 | 1 | 413-1 |
| CI 50 | 2.24 | 0.35 | 0.52 | 0.64 | 0.95 | 0.52 | 0.89 | 1.50 | 0.40 | 1.35 | 1.54 | 0.06 | 0.60 | 0.89 | 0.44 |
| (g/L) | | | | | | | | | | | | | | | |
| CMI | 4.55 | 0.68 | 3.66 | 1.30 | 1.27 | 1.12 | 2.33 | 2.47 | 0.95 | 2.78 | 2.72 | 1.09 | 1.43 | 1.24 | 1.07 |
| (g/L) | | | | | | | | | | | | | | | |

IC50 values calculated for the different compositions fluctuate between 0.06 g/L (product 4, PV413-1) and 2.24 g/L (product 1, PV221), i.e., by a factor of 37, while MICs vary between 0.68 g/L (product 1, PV1538-1) and 4.55 g/L (product 1, PV221), i.e., by almost a factor of 7 (FIG. 3 and Table 4).

The mean IC50 and MIC values (in g/L) obtained for the 5 compositions are shown in FIG. 4 and Table 5 below.

TABLE 5
Mean IC50 and MIC values obtained for the 5 compositions

| | Product 1 | Product 2 | Product 3 | Product 4 | Product 5 |
|---|---|---|---|---|---|
| CI 50 | 1.04 ± 1.05 | 0.70 ± 0.22 | 0.93 ± 0.55 | 0.98 ± 0.81 | 0.65 ± 0.23 |
| CMI | 2.96 ± 2.03 | 1.23 ± 0.10 | 1.92 ± 0.84 | 2.20 ± 0.96 | 1.25 ± 0.18 |

2.3.3. Comparisons with Aqueous Potassium Bicarbonate Solution

Mean IC50 and MIC values are calculated for aqueous potassium bicarbonate formulations without any excipient (water+KHCO3 formulation), following the method described in sections 2.2.3 and 2.3.1 above. An aqueous sodium bicarbonate formulation without any other excipient (water+NaHCO₃ formulation) is also used as a control.

The results obtained are presented in Table 6 below.

TABLE 6
Mean IC50 and MIC values obtained for aqueous potassium
bicarbonate and sodium bicarbonate solutions

| | NaHCO3 | KHCO3 |
|---|---|---|
| CI50 | 1.85 g/L | 1 g/L |
| CMI | 10 g/L | 5.6 g/L |

The data show that the IC50 (dose inhibiting 50% fungal growth) and MIC (minimum inhibitory concentration) values obtained with products 2 and 5 (compositions according to the invention) are significantly lower than those obtained with the aqueous potassium bicarbonate or sodium bicarbonate solution. This highlights the superior efficacy of the compositions according to the invention against downy mildew, compared with the non-formulated active ingredient (aqueous potassium bicarbonate or sodium bicarbonate solution).

The IC50 values obtained with comparative products 1, 3 and 4 show no significant differences from those obtained for the aqueous potassium bicarbonate solution, under the conditions tested. On the other hand, these products have significantly lower MIC values than the aqueous sodium bicarbonate solution.

Thus, the MIC values of each of the products tested (1-5) compared with the unformulated active ingredient (potassium bicarbonate or sodium bicarbonate aqueous solution), reveal a significant improvement in the antifungal efficacy of each of the products tested (1.23 g/L to 2.96 g/L compared with 5.6 g/L respectively).

Overall, these data show that the various products tested have an antifungal effect that inhibits the growth of the fungus responsible for downy mildew on vines. The data show that products 1 to 5 have a significant and satisfactory antifungal effect. In particular, the best results were obtained with products 2 and 5, under the conditions tested. The compositions of products 2 and 5 therefore significantly improve the efficacy of potassium bicarbonate. The addition of the adjuvant to the formulation of product 5 did not significantly alter the efficacy of product 2, under the conditions tested.

The adhesion, spreading, resistance to leaching and longevity properties of each of the 1-5 products are tested on vine leaves and compared with those of an aqueous potassium bicarbonate solution.

Products 1-5, and in particular products 2 and 5, show improved adhesion, spreading, resistance to leaching and longevity on vine leaves, compared with the aqueous potassium bicarbonate solution.

### Example 3: Superior Antifungal Activity of Compositions According to the Invention

### Compositions Tested:

Product 1: 20F16GR01
Product 2: 20F17GR01
Product 3: 20F26WG01
Product 4: 20F29WG01
Product 5: 20G08WG01
Product 6: 20G09WG01

Products 1 to 6 are compositions according to the invention, the solid composition of which is given in Table 2 above.

### 3.1. Objective

The objective of this trial was to evaluate the efficacy of six additional potassium bicarbonate-based compositions according to the invention (Products 1-6) against phytopathogens, in particular downy mildew, and to define minimum inhibitory concentrations.

### 3.2. Materials and Methods

### 3.2.1. Plant Material

The plant material is as in Example 2 (vines) and is prepared as in Example 2 (paragraph 2.2.1 above).

### 3.2.2. Fungal Material

Fungal material is as in example 2 (downy mildew) and is prepared as in example 2 (paragraph 2.2.2 above).

### 3.2.3—Methods: In Vitro Efficacy Tests

Different concentrations of product are applied to leaf discs using an airbrush just before pathogen inoculation (extemporaneously). The discs are then air-dried for one hour.

Controls are performed by applying the same quantity of sterile distilled water to leaf discs.

Inoculation is carried out using a sporangia suspension prepared at 40,000 to 50,000 sporangia/ml, at a rate of 3 drops of 15 μl per leaf disc.

Treatment efficacy is determined by visual assessment of pathogen development after 7 days at 22° C.

Results are presented as the average percentage inhibition of fungal growth compared with the control modality, sprayed with sterile water, obtained by the following calculation:

% inhibition=100×1−(% growth “treated”/% growth “control”)

The value corresponding to the dose inhibiting 50% of fungal growth (IC50) and the minimum inhibitory concentration (MIC) are determined as in example 2 (paragraph 2.2.3 above).

Two independent experiments are carried out for each test.

### 3.3. Results

Tests were carried out on strains PV221, PV413-1 and PV1538-1, using 1 box of 8 treated leaf discs per modality and 6 different concentrations for each formulation tested (0 g/L, 0.35 g/L, 0.65 g/L, 1.25 g/L, 2.5 g/L, 5 g/L and 10 g/L).

### 3.3.1. Antifungal Activity

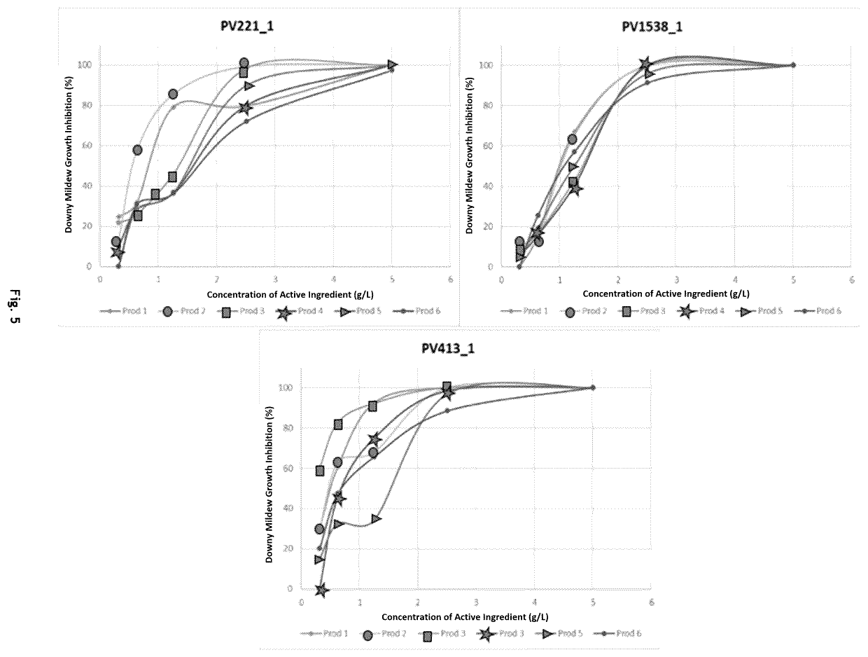

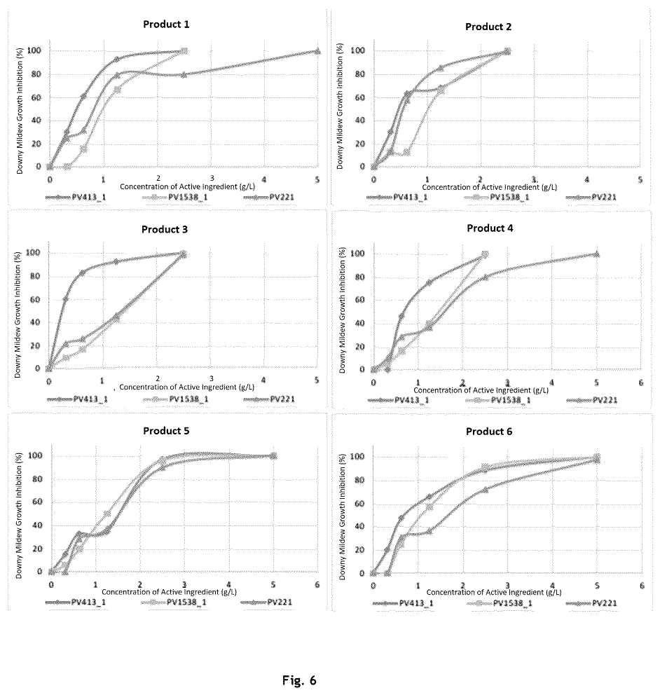

The results are shown in FIGS. 5 and 6. The data show that all six products tested are capable of inhibiting the growth of the various downy mildew strains tested. In the case of PV413-1 and PV221, the data show that product efficacy can vary depending on the strain tested, but also on the composition tested (FIG. 5).

On the other hand, the different compositions show fairly similar efficacy results for strain PV1538-1.

For strain PV413-1, products 1 and 3 were more effective than the other products, under the conditions tested.

For strain PV1538-1, products 1 and 3 were more effective than the other products.

For strain PV221, products 1 and 2 were more effective than the other products.

Products 1, 3 and 4 appear to be less effective against strains PV221 and PV1538-1 than against strain PV413-1 (FIG. 6). Product 2 appears to be the most effective against PV221 and product 5 against PV1538-1. Product 6 appears to be effective on strains PV413-1 and PV1538-1, under the conditions tested.

Moreover, the results obtained show a significant strain effect.

The data reveal that all the compositions tested are effective against the PV413-1 strain, isolated from resistant grapevine varieties. This is particularly interesting, as control of this type of pathogen is considerably more difficult.

### 3.3.2. Calculation of IC50 and MIC

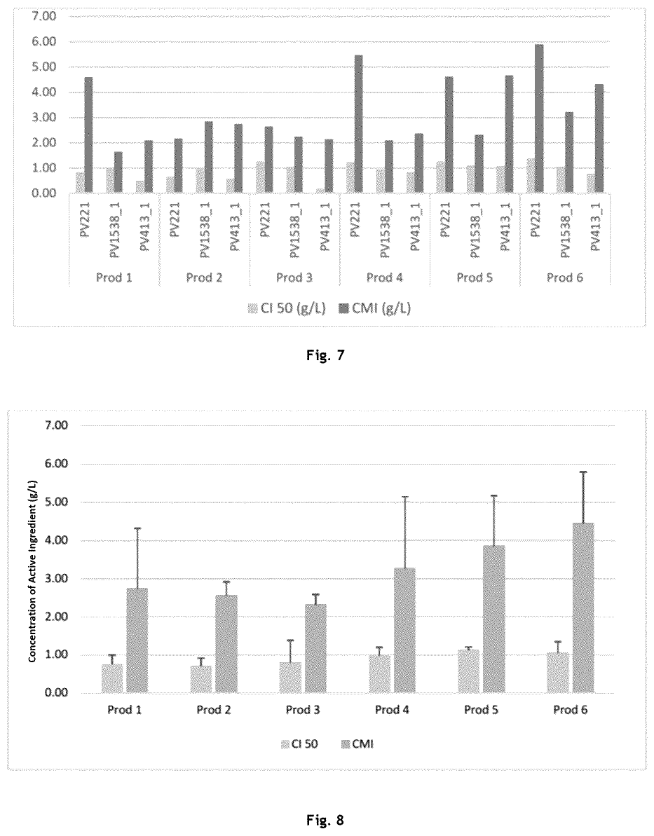

IC50 (values of x for which a value of 50 or 100 is obtained in y) and MIC values are determined from the equations of the curves obtained (FIGS. 5 and 6). The IC50 and MIC values obtained are shown in FIG. 7 and Tables 7 and 8 below.

TABLE 7
IC50 and MIC values obtained for the compositions tested (products 1-3) and each downy
mildew strain

| | Product 1 | | | Product 2 | | | Product 3 | | |
|---|---|---|---|---|---|---|---|---|---|
| Strain | PV221 | PV1538-1 | PV 413-1 | PV221 | PV1538-1 | PV 413-1 | PV221 | PV1538-1 | PV 413-1 |
| CI 50 (g/L) | 0.79 | 0.96 | 0.49 | 0.63 | 0.93 | 0.54 | 1.23 | 1.02 | 0.15 |
| CMI (g/L) | 4.54 | 1.61 | 2.04 | 2.13 | 2.80 | 2.71 | 2.61 | 2.21 | 2.11 |

TABLE 8
IC50 and MIC values obtained for compositions tested (products 4-6) and each downy
mildew strain

| | Product 4 | | | Product 5 | | | Product 6 | | |
|---|---|---|---|---|---|---|---|---|---|
| Strain | PV221 | PV1538-1 | PV 413-1 | PV221 | PV1538-1 | PV 413-1 | PV221 | PV1538-1 | PV 413-1 |
| CI 50 (g/L) | 1.21 | 0.90 | 0.80 | 1.22 | 1.08 | 1.05 | 1.35 | 1.03 | 0.76 |
| CMI (g/L) | 5.43 | 2.04 | 2.32 | 4.59 | 2.29 | 4.62 | 5.86 | 3.19 | 4.28 |

IC50 values for the different formulations fluctuate between 0.15 g/L (product 3, PV413-1) and 1.35 g/L (product 6, PV221), while MICs vary from 1.61 g/L (product 1, PV1538-1) to 5.86 g/L (product 6, PV221), i.e., by a factor of around 3 (FIG. 7, Tables 7 and 8), under the conditions tested.

The mean IC50 and MIC values (in g/L) obtained for the 6 compositions are shown in FIG. 8 and Table 9 below.

TABLE 9
Mean IC50 and MIC values obtained for the 6 compositions.

| | Product 1 | Product 2 | Product 3 | Product 4 | Product 5 | Product 6 |
|---|---|---|---|---|---|---|
| CI 50 | 0.75 ± 0.24 | 0.70 ± 0.20 | 0.80 ± 0.58 | 0.97 ± 0.22 | 1.12 ± 0.09 | 1.05 ± 0.29 |
| CMI | 2.73 ± 1.58 | 2.55 ± 0.37 | 2.31 ± 0.27 | 3.26 ± 1.88 | 3.83 ± 1.34 | 4.44 ± 1.34 |

3.3.3. Comparison with an Aqueous Potassium Bicarbonate Solution

The mean IC50 and MIC values calculated for the compositions according to the invention are compared with those calculated for aqueous potassium bicarbonate formulations without any excipient (water+KHCO3 formulation) and aqueous sodium bicarbonate formulations without any other excipient (water+NaHCO₃ formulation) and presented in table 6 above (paragraph 2.3.3).

Comparisons show that IC50 values (dose inhibiting 50% of fungal growth) and MIC values (minimum inhibitory concentration) obtained with products 1 to 3 (compositions according to the invention) are significantly lower than those obtained with the aqueous potassium bicarbonate or sodium bicarbonate solution.

The IC50 values obtained with products 4 to 6 are comparable to those obtained with aqueous potassium bicarbonate solution, under the conditions tested. On the other hand, these products have significantly lower MIC values than sodium bicarbonate aqueous solution.

These results highlight the superior efficacy of the compositions according to the invention against downy mildew, compared with the unformulated active ingredient (aqueous potassium bicarbonate or sodium bicarbonate solution).

Thus, the MIC values of each of the products tested (1-6) compared with the unformulated active ingredient (aqueous potassium bicarbonate or sodium bicarbonate solution), reveal a significant improvement in the antifungal efficacy of each of the products tested (2.31 g/L to 4.44 g/L compared with 5.6 g/L respectively).

Products 1 to 3 were the most effective under the conditions tested (IC50s of 0.7 g/L and 0.8 g/L versus 1 g/L respectively).

Overall, these data show that the various products tested have an antifungal effect, inhibiting the fungal growth responsible for vine downy mildew. The data show that products 1 to 6 have a significant and satisfactory antifungal effect. In particular, the best results were obtained with products 1 to 3, under the conditions tested. The compositions according to the invention therefore significantly improve the efficacy of potassium bicarbonate.

The adhesion, spreading, resistance to leaching and longevity properties are tested on vine leaves for each of the 1-6 products and compared with those of an aqueous potassium bicarbonate solution.

The 1-6 products show improved adhesion, spreading, resistance to leaching and longevity on vine leaves, compared with the aqueous potassium bicarbonate solution.

### Example 4: Superior Antifungal Activity of Compositions According to the Invention on the Agent Responsible for Vine Downy Mildew (Plasmopara viticola) Under Semi-Controlled Greenhouse Conditions

### Compositions Tested:

Product 1: 20F17GR01
Product 2: 20F26WG01
Product 3: 20F29WG01
Product 4: 20B14GR01

Products 1 to 4 are compositions according to the invention, the solid composition of which is given in Table 2 above.

### 4.1. Objectives

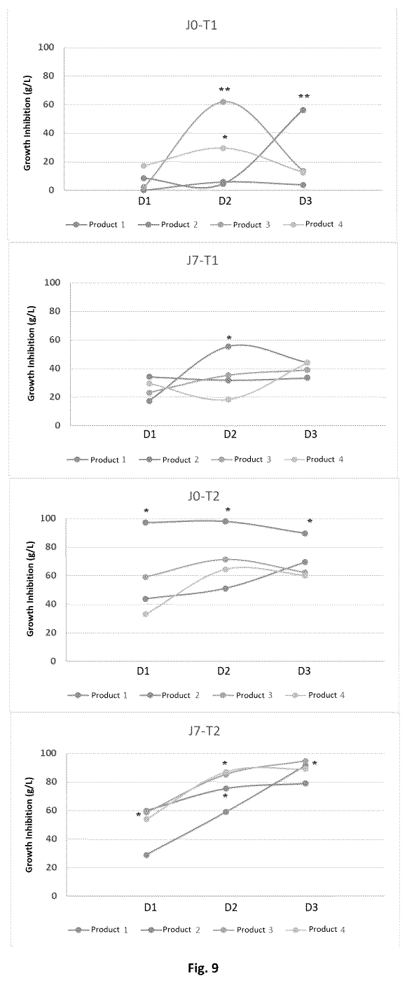

The objectives of this trial were to evaluate the efficacy of 4 additional potassium bicarbonate-based compositions according to the invention (Products 1-4 in FIGS. 9 to 12), against phytopathogens, in particular vine downy mildew. More specifically, the objectives were to define the optimum dose to be applied in the vineyard, as well as application strategies based on the characteristics of the products (phytotoxicity, persistence, resistance to leaching).

### 4.2. Materials and Methods

### 4.2.1. Plan Material

The plant material is as in Example 2 (vines). These are leaf cuttings of the Cabernet-Sauvignon grape variety with at least 4 spreading leaves (plants 1 to 2 months old).

The plant material is prepared as in example 2 (paragraph 2.2.1 above).

### 4.2.2. Fungal Material

The fungal material is as in Example 2 (vine downy mildew, Plasmopara viticola) and is prepared as in Example 2 (paragraph 2.2.2 above).

4.2.3—Methods: In Vitro Efficacy Tests The methods are as in example 2 (paragraph 2.2.3 above).

### 4.3. Results

### 4.3.1. Dose Effect on Vine Plants

In this trial, 5 plants per test condition are used, to ensure the 4 leaf samples required for the in vitro fungicide efficacy tests to be carried out in the laboratory.

Two consecutive applications are made 10 days apart on all cuttings (first treatment: T1; second treatment: T2).

Three doses are tested for each formulation: 1 to 1.2×MIC obtained in the laboratory, 2.5 to 3×MIC and 5 to 6×MIC, depending on the formulation.

To assess the fungicidal efficacy of the different products tested, 5 leaves (3rd or 4th leaf from the apex) were taken from each plant, 1 leaf per plant just after T1 and T2, then 7 days after each treatment. In the laboratory, 3 Petri dishes containing 6 discs of 20 mm-diameter leaves are prepared for each treatment modality. Inoculation is carried out using a sporangia suspension prepared at between 5,000 and 10,000 sporangia/ml, at a rate of 3 drops of 15 μl per leaf disk.

Pathogen growth is assessed after 7 days incubation at 22° C.

Results are presented as the average percentage inhibition of fungal growth compared with the control modality, sprayed with sterile water, obtained by the following calculation:

% inhibition=100×1−(% growth “treated”/% growth “control”)

### Result

TABLE 10
Characteristics of the different products tested in these trials

| | | | | | |
|---|---|---|---|---|---|
| ID | Reference | Batch | % MA | CI50 (g MA/L) | CMI (g MA/L) |

| | | | | | | |
|---|---|---|---|---|---|---|
| Product 1 | 20-F17-GR01 | 19-121-F-WG-02 | batch 21C18WG01 | 52.50% | 0.7 +/− 0.20 | 2.55 +/− 0.37 |
| Product 2 | 20-F26-WG01 | 19-121-F-WG-03 | batch 21C18WG02 | 55% | 0.8 +/− 0.58 | 2.31 +/− 0.27 |
| Product 3 | 20-F29-WG01 | 19-121-F-WG-04 | batch 21C19WG01 | 60% | 0.97 +/− 0.22 | 3.26 +/− 1.88 |
| Product 4 | 20-B14-GR01 | 19-121-F-WG-07 | batch 21C22WG01 | 50% | 0.7 +/− 0.22 | 1.23 +/− 0.1 |

TABLE 11
Actual MICs (g MA/L) of the different doses of the 4 products
prepared for the trials: CM factor

| | dose 1 (g PF/L) | dose 2 (g PF/L) | dose 3 (g PF/L) |
|---|---|---|---|
| Product 1 | 1.05 | 2.625 | 5.25 |
| Product 2 | 1.1 | 2.75 | 5.5 |
| Product 3 | 1.2 | 3 | 6 |
| Product 4 | 1 | 2.5 | 5 |

FIG. 9 shows that, immediately after the first treatment (DO-T1), the best results are obtained with the medium dose (D2) of product 3 and the high dose (D3) of product 2, with protection of around 60%. Intermediate results were obtained with the medium dose (D2) of product 4 (30%).

Seven days after treatment 1, the medium dose (D2) of product 1 gives excellent protection (55%).

The other doses and products also provide significant protection (between 17 and 44%).

Just after treatment 2, the three doses (D1, D2 and D3) of product 2 gave excellent protection results (between 89 and 97%), and the levels of protection obtained with the other doses of the other products provided significant protection of between 32 and 70%.

Seven days after the second treatment, all doses of the 4 products provided significant protection (between 50 and 95%). The protection provided by the first dose of product 1 is lower (28%) but still significant.

### 4.3.2. Phytotoxicity

### Phytotoxicity

Phytotoxicity tests were carried out. In these trials, 5 plants per condition were used.

Two consecutive applications were made 10 days apart to all the cuttings.

Three doses were used for each formulation: 2×MIC obtained in the laboratory, 5×MIC and 10×MIC.

Phytotoxicity ratings are taken just before the first treatment (T1) to serve as a reference, then just before the second treatment (T2) and 7 days after the two treatments (T1 and T2) on each leaf level of the plant from the apex.

### Results

TABLE 12
Phytotoxicity evaluation of different doses of the 4 products tested:

| | | Phytotoxicity (%) | | | |
|---|---|---|---|---|---|
| | | J0 T1 | J + 7 T1 | J + 10 | J + 7 T2 |
| Product 1 | [ ] min | 0 | 5.30 | 5.30 | 36.38 |
| | [ ] med | 0 | 10.98 | 7.89 | 57.06 |
| | [ ] max | 0 | 30.05 | 32.55 | 77.38 |
| Product 2 | [ ] min | 0 | 0.00 | 0.00 | 0.00 |
| | [ ] med | 0 | 1.01 | 0.81 | 2.71 |
| | [ ] max | 0 | 5.00 | 3.55 | 5.00 |
| Product 3 | [ ] min | 0 | 0.00 | 0.00 | 0.00 |
| | [ ] med | 0 | 0.00 | 0.00 | 0.00 |
| | [ ] max | 0 | 5.00 | 5.00 | 10.00 |
| Product 4 | [ ] min | 0 | 0.00 | 0.00 | 0.00 |
| | [ ] med | 0 | 0.00 | 0.00 | 0.00 |
| | [ ] max | 0 | 1.99 | 2.06 | 11.23 |

The data in Table 12 show that Product 1 induces moderate phytotoxicity, which increases with the dose.

Phytotoxicity observed with Product 2 is significantly lower. No phytotoxic reactions were observed for the low and intermediate doses of Products 3 and 4.

### 4.3.3. Product Persistence (in the Absence of Leaching)

The objective of this trial was to evaluate the persistence of efficacy of the formulated products on the plant after treatment. In this set-up, 10 plants per condition were used.

A single dose was selected, between 6 and 12 g/l of product 4: the optimum dose determined after the trials described above (paragraphs 4.3.1 and 4.3.2), which could be selected for use in the vineyard.

This trial was carried out under semi-controlled greenhouse conditions. As for trial 1, 5 leaves (3rd or 4th leaf from the apex) of each modality are taken just after treatment (extemporaneously) and then 3, 7 and 10 days after treatment, and brought back to the laboratory to assess the effectiveness of protection against downy mildew. As with a conventional in vitro efficacy test, 3 boxes of 6 to 8 20 mm-diameter leaf discs are prepared for each treatment modality. The leaf discs are inoculated with 3 drops of 15 μl per disc of sporangia suspension.

Pathogen growth is assessed after 7 days' incubation at 22° C.

Results are presented as the average percentage inhibition of fungal growth compared with the control modality, sprayed with sterile water, obtained by the following calculation:

% inhibition=100×1−(% growth “treated”/% growth “control”).

### Results

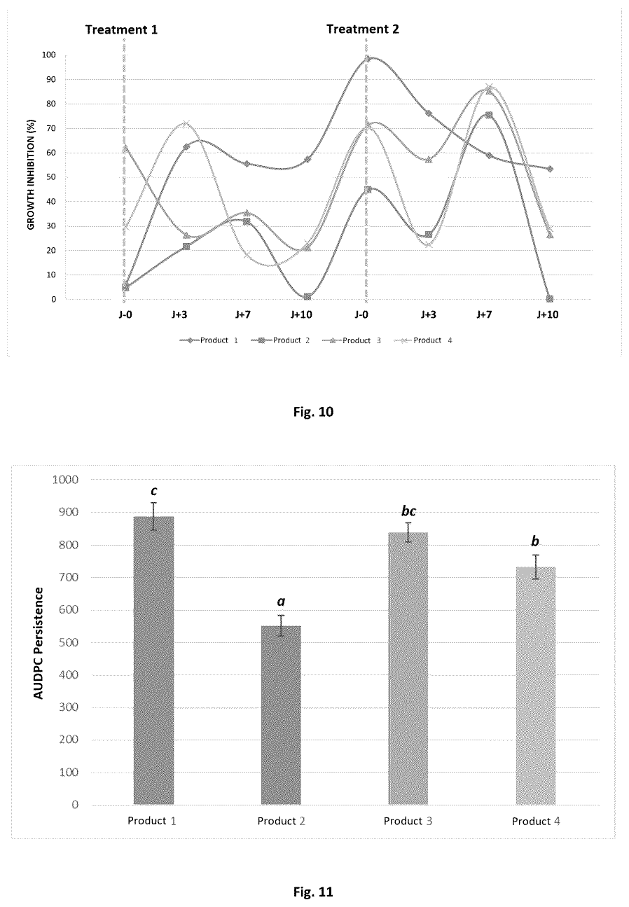

FIGS. 10 and 11 show that products 1 and 3 give the best persistence results, at the average dose used. Products 2 and 4 also offer good persistence.

### 4.3.4. Resistance to Leaching

The objective of this trial was to assess the resistance to leaching of the formulated products. In this trial, 10 plants were used per condition tested.

The dose used is the optimum dose, between 6 and 12 g/l of product 4, determined after the trials described above (paragraphs 4.3.1 and 4.3.2), which can be selected for use in the vineyard.

Treated plants are placed on a test platform equipped with an oscillating irrigation system. Cumulative rainfall of 25 mm or a 20 mm thunderstorm are simulated. These conditions are sufficient to wash away the treatment products, thus rendering the effects of a treatment null and void, even if it was carried out a few hours earlier.

As in previous trials, after drying, 5 leaves (3rd or 4th leaf from the apex) from each plant are removed and brought back to the laboratory to assess the effectiveness of protection against downy mildew. Three boxes of 6 to 8 discs of 20 mm-diameter leaves are prepared for each treatment condition. The leaf discs are inoculated with 3 drops of 15 μl per disc of sporangia suspension.

Pathogen growth is assessed after 7 days' incubation at 22° C.

Results are presented as the average percentage inhibition of fungal growth compared with the control modality, sprayed with sterile water, obtained by the following calculation:

% inhibition=100×1−(% growth “treated”/% growth “control”).

### Results

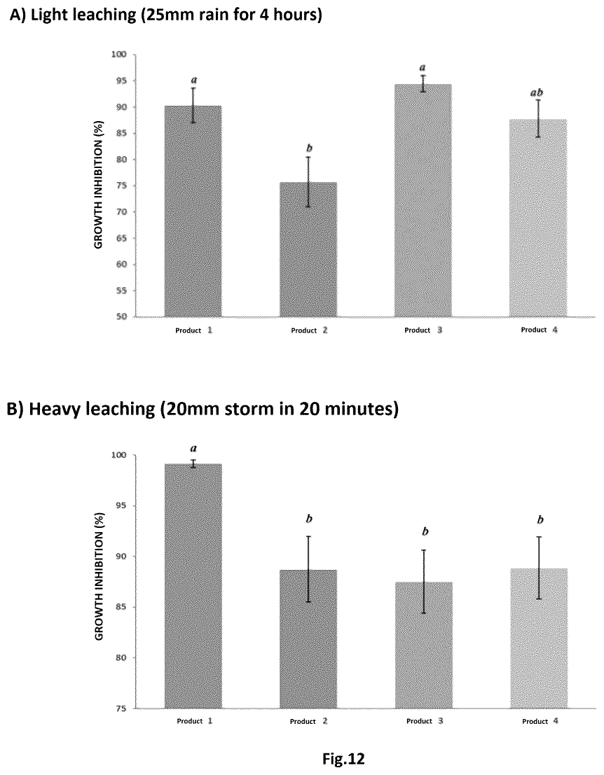

The data obtained are shown in FIG. 12. They show that, irrespective of leaching, products 1, 3 and 4 give the best results overall (between 90 and 95% protection). The antifungal activity of these products remains very high even after heavy leaching (between 85 and 90% protection). The efficacy of product 2 remains very good (75% protection after fine leaching, but almost 90% protection after heavy leaching).

### Assessment of Example 4

The results confirm that the 4 compositions according to the invention, tested in this example, are all effective in preventing and treating downy mildew on vine plants. The protection provided by these products is stable and long-lasting. In addition, these products all offer excellent resistance to leaching, further extending the duration of protection. Finally, the data show that the 4 products tested have acceptable phytotoxicity. Taken as a whole, the data indicate that product 3 is the most interesting, in terms of efficacy, phytotoxicity and duration of protection.

### Example 5: Superiority of the Antifungal Activity of Compositions According to the Invention on the Agent Responsible for Downy Mildew of Solanaceae (Phytophtora infestans) Under Semi-Controlled Greenhouse Conditions

### Composition Tested:

Product 3 from Example 4 according to the invention (20F29WG01), whose solid composition is given in Table 2 above, was used in these tests at different concentrations (0 kg/100 L, 0.3 kg/100 L, 0.6 kg/100 L, 0.9 kg/100 L and 1.2 kg/100 L).

### 5.1. Objectives

The objectives of this trial were to evaluate the efficacy of the potassium bicarbonate-based product 3 according to the invention, against phytopathogens, in particular downy mildew of solanaceous plants (Phytophtora infestans). More specifically, the objectives were to define the optimum dose to be applied to plants to obtain good efficacy of the product with reduced toxicity.

### 5.2. Materials and Methods

### 5.2.1. Plant Material

Production is carried out in the greenhouse, using young Solanum tuberosum (potato) plants. One tuber per 3 L pot is grown in the greenhouse. The plants are grown for 3 to 4 months. Tests are carried out on plants that have developed their 6th, 7th or 8th leaf. All plant leaves are infested with the pathogen to study the effect of product 3.

### 5.2.2. Fungal Material

Downy mildew is a strictly obligate pathogen, i.e., it cannot multiply in the absence of its host plant.

The strains used in these tests are Phytophtora infestans. The tests are carried out by inoculating all the leaves of each test plant. This is known as artificial infestation.

### 5.2.3. Methods: In Vitro Efficacy Tests

Different concentrations of the product are applied to the leaves of the plants using a lance with a spray nozzle (pressure 3 bar) just before the pathogens are inoculated (extemporaneously).

Controls are carried out by applying the same quantity of sterile distilled water to the plant leaves. Inoculation is carried out under standard conditions appropriate to the strain to be inoculated.

Treatment efficacy is determined by visual assessment of pathogen development after 7 days at 18° C.

Results are presented as the average percentage of fungus infestation compared with a non-inoculated plant.

### 5.3. Results

### 5.3.1. Dose Effect on Potato Plants

In this trial, 5 plants per test condition are used.

Two consecutive applications were made 7 days apart on all leaves (first treatment corresponding to the third treatment received by the plants: T3; second treatment corresponding to the fourth treatment received by the plants: T4).

Four doses were tested for product 3: dose 0.3 kg/100 L corresponding to 2.5×MIC obtained in the laboratory, dose 0.6 kg/100 L corresponding to 5×MIC, dose 0.9 kg/100 L corresponding to 7.5×MIC and dose 1.2 kg/100 L corresponding to 10×MIC.

To assess the fungicidal efficacy of the different concentrations tested, inoculation is carried out under standard conditions appropriate to the strain to be inoculated.

Inoculation takes place 1 day after application of the formulation according to the invention, or distilled water for the control condition.

Pathogen growth is assessed after 7 days incubation at 18° C.

Results are presented as the average percentage intensity of parasitic fungal infestation, by comparing fungal infestation between an inoculated and an uninoculated plant. Fungus infestation is observed visually.

### Results

TABLE 13
Pathogen infestation rates for different doses of product 3 after at
least 5 days and 12 days after treatment (T4) and crop inoculation

| | % infestation 5 days | % infestation 12 days |
|---|---|---|
| Doses used | after inoculation | after inoculation |
| Control | 18.1 | 21.3 |
| Dose 0.3 kg/100 L | 20.6 | 20.0 |
| Dose 0.6 kg/100 L | 20 | 16.3 |
| Dose 0.9 kg/100 L | 10.6 | 13.8 |
| Dose 1.2 kg/100 L | 15 | 11.9 |

The results show that after treatment (T4), inoculation and plant cultivation under conditions favorable to pathogen growth, the intensity of parasitic infestation increased to 18.1% after 5 days of inoculation, then to 21.3% after 12 days (Control).

At 5 days after inoculation, the two Product 3 modalities with doses of 0.9 kg/100 L and 1.2 kg/100 L were relatively less infested than the control.

By 12 days after inoculation, the reductions in infestation were significant. The 1.2 kg/100 L dose had a parasite infestation intensity of 11.9%; the 0.9 kg/100 L dose had a parasite infestation intensity of 13.8%. In comparison, the control had a parasitic infestation intensity of 21.3%.

### 5.3.2. Phytotoxicity

In this set-up, two consecutive applications were made at 7-day intervals (first treatment: T1, second treatment: T2), for the four doses tested (0.3 kg/100 L, 0.6 kg/100 L, 0.9 kg/100 L, 1.2 kg/100 L), as well as an application of distilled water corresponding to the control. Phytotoxicity results are obtained by leaf observation.

Phytotoxicity observations are also made after product application and pathogen inoculation. These applications (product+pathogen corresponding to T3 and T4 in section 5.3.1) are made 7 and 14 days after the two previous applications (T1 and T2).

Observation is particularly aimed at checking whether the leaves show any signs of necrosis around the edges of the leaf and/or dieback.

### Results

After the first two applications (T1 and T2), the crop showed no symptoms of phytotoxicity.

After the third application (T3), slight symptoms appeared: necrosis around the edges of the leaves and crop dieback.

After the third application (T4), the product induces more marked effects on the crop, but phytotoxicity remains very acceptable. It should be noted that greenhouse-grown plants are much more sensitive than those grown in the field.

### Assessment Example 5

For the different doses tested, product 3 induced little or no phytotoxicity on potato plants, for four applications at 7-day intervals.

Finally, the results confirm that product 3 is highly effective in preventing and treating late blight on potato plants. Overall, the 0.9 kg/100 L and 1.2 kg/100 L doses provide better protection, in terms of efficacy, with low toxicity.

### Discussion

The data show that products 2 and 5 from example 2 above, products 1 to 6 from example 3, products 1 to 4 from example 4 and product 3 from example 5 above have an antifungal effect and can prevent, treat and control the fungal growth responsible for downy mildew on vines, cucurbits and solanaceous plants when applied to leaves.

These products are particularly advantageous because they contain only biobased, phytosanitarily acceptable materials/ingredients. Moreover, these ingredients are biodegradable. In addition, they are particularly effective against fungus.

These 12 compositions have therefore been selected for their particularly pronounced efficacy in treating/controlling vine powdery mildew (Erysiphe necator or Uncinula necator), vine downy mildew (Plasmopara viticola), vine grey rot (Botrytis cinerea), solanaceous downy mildew (Phytophthora parasitica and/or Phytophtora infestans) and cucurbit downy mildew (Pseudoperonospora cubensis). These compositions are particularly effective in preventing and treating downy mildew on vines, cucurbits and solanaceous plants. The compositions of products 2 and 5 of example 2 (20B14GR01 with or without adjuvant) and of product 3 of examples 4 and 5, are those in particular which have shown the best performance and the most consistency when faced with inoculations of different strains of downy mildew.

According to the invention, the composition is innovative because:
It makes use of potassium bicarbonate against downy mildew of vines, cucurbits and solanaceous plants, which could be an alternative to the use of copper, which gradually contaminates and pollutes viticultural and agricultural soils year after year, treatment after treatment.
It uses a biodegradable active ingredient, potassium bicarbonate, which can be 100% biobased and, in particular, derived from a by-product of alcoholic fermentation, carbon dioxide (potassium carbonate+CO₂=potassium bicarbonate). This makes it possible to recover the gases produced during alcoholic fermentation and limit the release of carbon dioxide, a greenhouse gas that is detrimental to the ozone layer.
A novel combination of potassium bicarbonate and at least one excipient which may be essentially biobased and/or biodegradable (in particular a biobased and/or biodegradable anionic surfactant belonging to the taurate family), and at least one additional surfactant which may be essentially biobased and/or biodegradable (in particular a biobased and/or biodegradable anionic surfactant belonging to the taurate family); and at least one additional surfactant selected from anionic polyelectrolyte polymer surfactants, non-ionic surfactants, cationic surfactants, and any combination thereof; and optionally at least one additional excipient selected from clays).
The excipients used, in particular anionic surfactants belonging to the taurate family, improve the spreading and fixation of the active ingredient on the leaf and/or plant. By delaying water evaporation, they improve the quality of the contact film formed on the leaf by the other coformulants. Finally, they improve the formulation's resistance to cold.
The anionic polyelectrolyte polymer surfactant (notably lignosulfonates) is a dispersing agent with preservative properties. This excipient therefore improves the spreading of the active ingredient on the leaf and prolongs the composition's shelf life.
The non-ionic surfactant (in particular ethoxylated alcohols, such as Tergitol®) helps to create a fixing and protective film for the active ingredient on the leaf after application.

In particular, ethoxylated alcohols (such as Tergitol®) are wetting surfactants (they lower the surface tension to promote wettability of the powder or granules in water and of the liquid on the sheet during application).
In addition, cationic surfactants (such as siloxanes) are humectants with anti-foaming properties: they retain water and delay its evaporation, to improve the quality of the contact film formed on the sheet during drying.
Clay (especially silicates) has purifying, astringent and antiseptic properties. It thus complements and reinforces the antifungal activity of potassium bicarbonate, while prolonging the product's shelf life.
The formula is 100% natural, biobased, with extremely low environmental impact.
The final product can be in liquid, powder, granulated and/or tablet form, preferably in solid form. However, none of the products currently marketed to winegrowers or farmers are in granulated or tablet form.

1. A composition comprising:
potassium bicarbonate;
at least one excipient selected from the group consisting of anionic surfactants belonging to the taurate family; and
at least one additional excipient selected from the group consisting of anionic polyelectrolyte polymer surfactants, non-ionic surfactants, cationic surfactants, and any combination thereof;
the anionic polyelectrolyte polymer surfactants being selected from sulfonates, and any combination thereof; the nonionic surfactants being selected from ethoxylated alcohols, and any combination thereof; the cationic surfactants being selected from organo-mineral polymers, and any combination thereof.

2. The composition according to claim 1, wherein the composition is in solid form.

3. The composition according to claim 1, wherein:
the potassium bicarbonate content ranges from 5% to 90% by weight relative to the total weight of the composition; and/or
the content of anionic surfactants belonging to the taurate family ranges from 0.1% to 30% by weight relative to the total weight of the composition.

4. The composition according to claim 1, wherein the potassium bicarbonate is obtained from an alcoholic fermentation.

5. The composition according to claim 1, wherein at least one anionic surfactant belonging to the taurate family is selected from the group consisting of N-methyltaurates.

6. The composition according to claim 1, further comprising at least one additional excipient selected from the group consisting of clays, and any combination thereof.

7. The composition according to claim 6, wherein the clay is selected from the group consisting of silicates, and any combination thereof.

8. The composition according to claim 1, comprising at least one anionic polyelectrolyte polymer surfactant, selected from the group consisting of sulfonates, and any combination thereof.

9. The composition according to claim 1, comprising at least one non-ionic surfactant selected from the group consisting of ethoxylated alcohols, and any combination thereof.

10. The composition according to claim 1, comprising at least one cationic surfactant selected from the group consisting of organo-mineral polymers, and any combination thereof.

11. The composition according to claim 1, wherein:
i. the anionic polyelectrolyte polymer surfactant content ranges from 0.1% to 40% by weight based on the total weight of the composition; or
ii. the non-ionic surfactant content ranges from 0.01% to 40% by weight, based on the total weight of the composition; or
iii. the cationic surfactant content ranges from 0.001% to 30% by weight relative to the total weight of the composition; or
iv. the clay content ranges from 0.5% to 60% by weight relative to the total weight of the composition; or
v. the additional excipient content is any combination of at least two characteristics selected from i to iv.

12. The composition according to claim 1, comprising:
potassium bicarbonate;
at least one anionic surfactant belonging to the taurate family;
at least one anionic polyelectrolyte polymer surfactant;
at least one non-ionic surfactant;
at least one cationic surfactant; and
at least one clay.

13. The composition according to claim 1, wherein the composition is a phytosanitary composition.

14. The composition of claim 1, wherein the composition is essentially composed of biobased ingredients.

15. (canceled)

16. (canceled)

17. A method of protecting and/or treating crops, comprising applying the composition according to claim 1 to the crops to be protected and/or treated.

18. A method selected from those for:
protecting crops from fungal pathogens and/or diseases,
treating crops against fungal pathogens and/or fungal diseases,
controlling fungal pathogens and/or fungal diseases on crops, and
any combination thereof,
comprising the application of a composition according to claim 1 to said crops.

19. The method according to claim 18, wherein the fungal pathogen is selected from the group consisting of vine downy mildew (Plasmopara viticola), vine powdery mildew (Uncinula necator and/or Erysiphe necator), and vine rot (Botrytis cinerea), solanaceous downy mildew (Phytophthora parasitica and/or Phytophtora infestans) and cucurbit downy mildew (Pseudoperonospora cubensis).

20. (canceled)

21. (canceled)

22. Method of protecting and/or treating crops, comprising the application of a composition to the crops to be protected and/or treated;
the composition comprising potassium bicarbonate and at least one excipient selected from anionic surfactants belonging to the taurate family.

23. A method selected from those for:
protecting crops from fungal pathogens and/or fungal diseases,
treating crops against fungal pathogens and/or fungal diseases,
controlling fungal pathogens and/or fungal diseases on crops, and
any combination thereof,
comprising the application of a composition to said crops;
the composition comprising potassium bicarbonate and at least one excipient selected from anionic surfactants belonging to the taurate family.

24. The method according to claim 23, wherein the fungal pathogen is selected from the group consisting of vine downy mildew (Plasmopara viticola), vine powdery mildew (Uncinula necator and/or Erysiphe necator), vine rot (Botrytis cinerea), solanaceous downy mildew (Phytophthora parasitica and/or Phytophtora infestans) and cucurbit downy mildew (Pseudoperonospora cubensis).
